(19) United States
(12) Patent Application Publication
(10) Pub. No.: US 2017/0327140 A1
(43) Pub. Date: Nov. 16, 2017

(54) CARRIER DEVICE AND STOWING METHOD THEREOF

(71) Applicant: UNIQUE PRODUCT & DESIGN CO., LTD., Tainan City (TW)

(72) Inventor: Gordon LIAO, Tainan City (TW)

(21) Appl. No.: 15/664,701

(22) Filed: Jul. 31, 2017

Related U.S. Application Data
(63) Continuation-in-part of application No. 14/577,530, filed on Dec. 19, 2014, now Pat. No. 9,764,752.

(30) Foreign Application Priority Data
Jun. 27, 2017 (CN) 201720753661.0

(51) Int. Cl. B62B 3/02; B62B 3/12; B62B 3/10; B62B 7/06

(52) U.S. Cl. CPC B62B 3/02; B62B 3/12; B62B 7/06; B62B 3/102; B62B 3/106; B62B 2205/12

(57) ABSTRACT

A carrier device and a stowing method are disclosed. The rear wheel frame is disposed on the front wheel frame. The front wheel is disposed on a first end of the front wheel frame. The rear wheels are disposed on two ends of the rear wheel frame. The upper frame is disposed on a second end of the front wheel frame. The upper stoppers are disposed on the handle frame linkage, the upper frame or the handle frame. The carrier device has a stowing state including a stowing position, in the stowing position, a plane formed by the front wheel and a plane formed by one of the rear wheels are substantially perpendicular to each other, and the upper stoppers are disposed on two sides of the plane formed by the front wheel respectively. This disclosure has the advantages of easy folding and stowing.

### CROSS REFERENCE TO RELATED APPLICATIONS

This application is a continuation-in-part (CIP) application of U.S. Ser. No. 14/577,530, filed Dec. 19, 2014, and claims priority under 35 U.S.C. §119(a) on Patent Application No(s). 201720753661.0 filed in People's Republic of China on Jun. 27, 2017, the entire contents of which are hereby incorporated by reference.

### BACKGROUND OF THE DISCLOSURE

### Field of Disclosure

This disclosure provides a carrier device and a stowing method thereof. This disclosure relates to wheeled carts (can be called carrier devices) and particularly to wheeled cargo carrying devices, for transporting general cargo, luggage, golf bags, or for functioning as a baby stroller.

This disclosure relates to fold flat, compact components for wheeled carts and provides for convenient, compact stowed orientation of at least three wheels on such carrier devices. Inventors in wheeled cargo carrying device carts continually strive to achieve compact, convenient stowed positions of the devices so that they take up very little storage space. One disclosure disclosed for cargo carrying devices provides that a rear wheel frame, with at least two rear wheels, swivels in relation to a front frame—and the swiveling or rotating motion of the rear frame synchronously operates to fold and stow the two rear wheels of the device. Further, in the operative position most similar cart devices feature a front frame and a wheel oriented perpendicular to a rear frame which rear frame includes a pair of rear wheels. In each embodiment of this disclosure, the front frame moves into a stowed orientation, closely adjacent to, and parallel with, the rear frame. In this stowed configuration, at least one front wheel and the rear frame wheels are linearly aligned occupying a co-planar relationship, and are all parallel with the rear and the front frame together forming one combined side elevational profile of the over-all compact, stowed carrier. The innovations are applicable to carrier devices, golf bag carriers, baby strollers, carts, dollies, and trolleys, and the innovations provide for an ultra-thin compact stowed profile of the wheeled carrier device.

### Related Art

Applicant's prior U.S. patents include, but are not limited to U.S. Pat. Nos. 8,720,912, 8,613,463, 8,544,871 and 8,500,140 among many others. Many of applicant's disclosures seek to achieve compact stowed golf carts or baby stroller wheel designs so that the consumer may conveniently fold the device when not in use, and the products each achieve a compact stowed position. In the preferred embodiments of this particular disclosure, the device has a three-wheel orientation, and simple movement of both the front wheel, and of the at least two rear wheels, provides for folding and compacting of the wheels, without their removal, and results in the ultra-thin stored profile. In the above-mentioned previous U.S. Pat. No. 8,544,871, this inventor provided for synchronous folding of at least two rear wheels by virtue of at least one gear that synchronously caused movement and stowing of at least two rear wheels when a portion of the wheeled carrier device frame was folded. This application builds on the concept of synchronously folding at least two rear wheels of a wheeled carrier device, however; the synchronous folding of the at least two rear wheels is accomplished by either: 1) a unique swiveling motion of the rear wheel frame in relation to the forward wheel frame and/or the upper frame; or 2) the rotation of the forward frame in relation to the rear frame, however, unlike the foldable carrier devices of the prior art, this cart device achieves a stowed status of the forward and the rear wheels in a linear alignment, where each of the wheels' axis of rotation are co-planar and closely adjacent to the rear, forward and upper frame stowed parts. Further, this disclosure does not have a gear which transfers the synchronous motion (like the applicant's prior art) but instead uses a series of linkages and connectors between the rear wheel frame and the other frame parts, and the rotation motion of the rear frame in relation to the remaining carrier parts is what provides for the synchronous folding and set up of the at least two rear wheels.

Moreover, a small-sized wheeled carrier device, such as a golf cart, a baby stroller, a shopping cart, or another type of cart, can provide much convenience for people's travel, daily life, shopping or entertainment. If the carrier device is equipped with a folding function, users can fold it for the carrying, transportation or storage with convenience.

However, although the carts can provide some convenience for the people's use, the user will face a very complicated folding process when needing to stow it. Besides, the cart will take too much room even after being folded, so as not to facilitate the carrying, transportation or storage for the user.

### SUMMARY OF THE DISCLOSURE

This disclosure provides a carrier device and a stowing method thereof.

This disclosure provides for compact, ultra-thin profiles for wheeled carts, such that none of the wheels need to be detached, but can be simply manipulated into an orientation which situates all the folded wheels axis of rotation into co-planar relationship with a forward and rear frame, conveniently providing for a compact device, and simple reversing movements of the wheels from their stowed position allows for their operative position set up.

One of the purposes of this disclosure is to provide for a forward frame and wheel that may be swept through an angle, into a compact orientation, closely adjacent to the rear wheel frame, and reversing motions allow for the setup of the same wheel.

One of the purposes of the disclosure is to provide for an extensible and retractable wheel arm for the forward wheel that is conveniently turned, and retracted into a compact forward wheel position, without wheel detachment. In a second embodiment, the forward wheel is not retracted, but is swept through an angle into a co-planar relationship with the device wheels.

Another purpose of the disclosure is to provide for a simple manually manipulable latch which allows for release of the operative position of the forward wheel, allowing it to be simply rotated along a guide channel so that the wheel may be easily stowed and can only be stowed by the user in one manner during the stowing motion.

Another object of the disclosure is to provide for a simple mounting bracket for a forward wheel of a carrier device, which provides a guide channel incorporated into the forward frame mounting bracket, to allow the extension and retraction of the forward wheel, and which provides a latching means within the mounting bracket for said forward wheel.

Another object of the disclosure is to provide that the mounting bracket on the forward wheel frame also includes cargo retaining means that are oriented into the mounting bracket of the forward wheel frame.

Another object of the disclosure is to provide for an upper frame of a wheeled carrier device that includes at least one upper stage in addition to a lower stage, which may be manually manipulated to various ergonomically advantageous positions to accommodate different height users.

Another object of the disclosure is to provide that the upper frame includes a handle grasp, and a portion of the upper frame, in the operative position, is retained to a portion of a lower frame by gravitational or resilient forces, and the same upper frame achieves a stowed compact position where the two upper frame stages become co-planar to one another in the collapsed state of the device.

Another object of the disclosure is to provide that the forward wheel frame includes a mounting bracket on which the rear wheel frame and at least two rear wheels are mounted.

Another object of the disclosure is to provide that at least two rear wheels and a rear mounting frame may be mounted to a forward wheel frame, and the rear wheel frame swivels or moves along an interconnection assembly (or a synchronous folding assembly) which facilitates motion that synchronously folds the rear wheels from an operative position to a fully stowed position where the rear two wheels, when stowed, are co-planar to each other and are parallel with the forward and the rear wheel frames, and a rear wheel frame finger grasp may be provided to facilitate easy swiveling of the rear wheel frame between the stowed and the operative positions.

Another object of the disclosure is that when the user manually moves either of the two rear wheels to achieve their stowed position, a series of linkages and joints synchronously sweep the position of each of the two rear wheels from the operative to the stowed position, and vice-versa, by the simple 90-degree swiveling or folding of the rear wheel frame, either clockwise, or counter-clockwise, in relation to the forward frame of the device to which it is movably secured. Similarly, another embodiment provides that the rotational motion of the forward frame in relation to the rear wheel frame provides the synchronous folding and unfolding of the rear wheels through a series of linkages between the said parts.

Another object of the disclosure is to provide for a rear wheel frame interconnection assembly, which is mounted to a portion of the front wheel frame mounting bracket, and the assembly has a series of linkages to a series of sliders mounted on the rear wheel frame, and the sliders further connect to a movable joint attached to each of the rear wheel axles, so that when the rear wheel frame is swiveled 90 degrees along the interconnection assembly securing point, it synchronously turns each of the two rear wheels, in tandem, from an operative wheel position perpendicular with the rear wheel frame to a stowed position wherein the two wheels and the entire rear wheel frame are substantially parallel with the rear wheel frame and closely contiguous to same, and reversing movements also synchronously move the rear wheels and the rear frame from the compact, stowed position to the fully operative, in use position.

Another purpose of the disclosure is to provide that the rear wheel frame interconnection assembly may be swiveled in a single direction, so that the user can only accomplish the folding, or the set up, of the rear wheel frame in the proper intended direction, or alternatively, the rear frame may instead be movable from an operative orientation perpendicular to the longitudinal direction of the forward frame, with the rear wheels in the operative status, to a rear frame stowed orientation co-planar and parallel to the forward frame, with the rear wheels folded closely adjacent the rear frame, aligning each rear wheel and the forward wheel's axis of rotation in alignment closely adjacent and along the longitudinal plane of the forward frame.

Another purpose of the disclosure is to provide that simple rotational movement of the forward wheel frame causes synchronous motion to be transferred by a series of linkages to rear wheels and the rear wheel frame, so that the folding motion of at least the forward frame and forward wheel in relation to the rear wheel frame, synchronously folds and stows the rear wheels, as well as the rear wheel frame, so that all wheels are co-planar and linearly aligned when stowed, closely adjacent to the forward frame, and in addition, closely adjacent to the upper frame forming a hand grasp. This and other portions of the innovations are further outlined in this application.

Another purpose of the disclosure is to provide a wheeled foldable carrier device. The carrier device of this disclosure not only has the advantage of easy folding, but also won't take too much room after the folding, so as to facilitate the carrying, transportation or storage for the user.

The disclosure further disclose a carrier device, which includes a front wheel frame, a rear wheel frame, a front wheel, a plurality of rear wheels, an upper frame, a handle frame, a handle frame linkage and two upper stoppers. The front wheel frame including a first end and a second end. The rear wheel frame is disposed on the front wheel frame. The front wheel is disposed on the first end of the front wheel frame. The rear wheels are disposed on two ends of the rear wheel frame respectively. The upper frame is disposed on the second end of the front wheel frame and adjacent to the rear wheel frame. The handle frame is disposed on the upper frame. The handle frame and the upper frame are connected to each other through the handle frame linkage. The upper stoppers are disposed on the handle frame linkage, the upper frame or the handle frame. The carrier device has a stowing state including a stowing position. In the stowing position, a plane formed by the front wheel and a plane formed by one of the rear wheels are substantially perpendicular to each other, and the upper stoppers are disposed on two sides of the plane formed by the front wheel respectively.

In the carrier device and the stowing method thereof according to the disclosure, when the carrier device is in the stowing position, the plane formed by the front wheel and the plane formed by one of rear wheels are substantially perpendicular to each other, and the upper stoppers are disposed on two sides of the plane formed by the front wheel respectively. By the above design, the carrier device will have a very simple stowing or stretching process, and besides, the front wheel, the front wheel frame and the two upper stoppers will not undergo the positional interference during the stowing process and at the stowing state. Therefore, the carrier device of this disclosure not only has the advantage of easy folding, but also won't take too much room after the folding, so as to facilitate the carrying, transportation or storage for the user.

### BRIEF DESCRIPTION OF THE DRAWINGS

The disclosure will become more fully understood from the detailed description and accompanying drawings, which are given for illustration only, and thus are not limitative of the present disclosure, and wherein:

FIG. 1 a perspective of carrier device, in accordance with one aspect of the present disclosure, in a fully operative position including a view of the forward frame, the rear frame, and the lower and upper stages of the upper frame, this figure, along with FIG. 2 beside it, are the preferred cover drawing figures.

FIG. 2 is an underside plan view of the fully stowed carrier device of FIG. 1 showing each of the frame parts in a parallel configuration and all of the stowed wheels in a co-planar configuration.

FIG. 3 is a slightly elevated view of the carrier device, similar to FIG. 1 with the one change being the forward wheel has been released from its operative position and the movable wheel arm has been retracted along the forward frame toward the rear frame;

FIG. 4 is an end elevational view, slightly elevated, indicating that the upper and lower stages of the upper frame has been folded down into a configuration contiguous to, and parallel with, the forward wheel frame.

FIG. 5 is an underside view, cut away, of the forward wheel frame and the front wheel movable wheel arm including portions of the forward wheel mounting bracket.

FIG. 6 is an axial view along the front wheel movable wheel arm, cut away for a perspective, showing the front wheel bracket shaped guide path.

FIG. 7 is cut away side elevational view of the front wheel movable wheel arm, including the series of protrusions which interact with the front wheel bracket shaped guide path retraction and extension channel.

FIG. 8 is a view similar to FIG. 5 except a latching portion of the front wheel movable wheel arm has been rotated 90 degrees out of a receiving portion of the front wheel mounting bracket, and a series of protrusions along the front wheel movable wheel arm are in alignment with a receiving channel forming a slide path or guide way;

FIG. 9 is an end elevational axial view of the front wheel mounting bracket, cut away for this depiction, also showing the latching protrusion that forms a part of the forward wheel movable wheel arm, allowing for its retraction, extension and securement along the front wheel frame.

FIG. 10 is a top plan view of the rear wheel frame and its swivel assembly, partly cut away to improve the view of the component parts, which parts cooperate to synchronously swivel in relation to the front device frame, and the swiveling provides for the stowing and/or setup of each of the two rear wheels and the rear frame in a synchronous manner.

FIG. 11 is an end elevational view of the rear wheel frame and component parts interconnecting the rear wheels with the swivel assembly which components synchronously provides for setup and folding of the rear wheels and the rear wheel frame.

FIG. 12 is an underside plan view of the rear wheel frame partially swiveled between the operative and stowed positions showing the swivel assembly components and each of the rear tires, shown in a first intermediate position between operative and stowed positions, and showing the forward wheel in a fully stowed position.

FIG. 13 is an underside plan view of the rear wheel frame partially swiveled between the operative and stowed positions showing the swivel assembly components and each of the rear tires, shown in a second intermediate position between operative and stowed positions, and showing the forward wheel in a fully stowed position.

FIG. 14 is underside plan view of the fully stowed carrier device with all wheels in their stowed positions, co-planar, and with said rear wheels and rear frame in a parallel configuration with the forward frame creating a thin stowed profile.

FIG. 15 is a bird's eye elevated view of simplified alternate wheeled cart device in accordance with another embodiment of the present disclosure, shown in a fully operative position;

FIG. 16 is also a bird's eye slightly elevated view of carrier device of FIG. 15, showing an intermediate folding position where the upper frame is in the beginning stage of the folding the unit toward the fully stowed position;

FIG. 17 is a side elevational profile view of FIG. 15 showing the similar folded position as in FIG. 16, where the rear wheels have begun rotation toward the stowed position;

FIG. 18 is a side elevational view of the wheel carrier device of FIG. 15 shown in the fully folded status, with all wheels of the device in a co-planar position;

FIG. 19 is a top plan view the wheel carrier device of FIG. 15, shown in the fully operative position;

FIG. 20 is a top plan view of the wheel carrier device of FIG. 15, shown in the beginning stages of the folding process towards the stowed position, showing an intermediate status of the rear wheels as well as of the front wheel;

FIG. 21 is a side elevational view of the carrier device of FIG. 15 in the fully stowed position showing the co-planar view of the wheels of the device parallel with the frame portions;

FIG. 22 is an underside plan view of the carrier device of FIG. 15, showing the folded frame portions.

FIG. 23 is a schematic diagram of a carrier device of the first embodiment of the disclosure;

FIG. 24 is a schematic flowchart of the stowing method of the carrier device of FIG. 23;

FIGS. 25 to 30 are schematic diagram of the stowing process of the carrier device 9 of FIG. 23; and

FIG. 31 is a schematic diagram showing the connection of the upper stopper with the upper stopper linkage of the carrier device of a different embodiment.

### DETAILED DESCRIPTION OF THE DISCLOSURE

The present disclosure will be apparent from the following detailed description, which proceeds with reference to the accompanying drawings, wherein the same references relate to the same elements.

Referring to the drawing figures the following are the description of the numbered elements: 100 carrier device cart embodiment; 101 simplified alternate carrier device cart embodiment; 1 front wheel frame; 1a front forward portion; 1b rear portion; 2 front wheel; 2a front wheel axle; 3 rear wheel frame; 4 rear wheel; 4a, 4b rear wheel axels; 5 front frame cargo retaining means; 6 lower stage of upper frame; 7 upper stage of upper frame; 7a upper frame connection joint; 7b upper frame adjustment means; 7c upper frame cargo retaining means; 7d push-pull handle grasp; upper frame 8; 11 front frame arm; 11a front wheel arm variation; 12 front frame mounting bracket; 31 rear frame mounting arm; 32 rear frame mounting bracket; 32-A swivel assembly; 51 front wheel movable wheel arm; 51a front wheel fixing mount; 52 front wheel mounting bracket; 53 front wheel arm securing means; 54 manually manipulable latch; 55 latch resilient retaining means; 56 front wheel mounting bracket securing means; 311 rear frame wheel mount; 312 lateral plane of rear frame portion; 321 swivel assembly guide channel; 331 swivel assembly linkage; 332 rear frame slider; 333 rear wheel movable linkage; 334 rear wheel mounting axle; 335 wheel axis of rotation; 338 fixation member; 339 swivel assembly securing member; 340 rear frame swiveling finger grip; 341 movable parking brake; 342 upper to front frame linkage; 343A first frame linkage A; 343B second frame linkage; 511 front wheel arm male-female guides; 521 front wheel bracket shaped guide channel; 521a front wheel bracket shaped guide latching channel; 521b front wheel mounting bracket movable wheel arm receiving means; 522 front frame slider ring; and 523 side elevational profile.

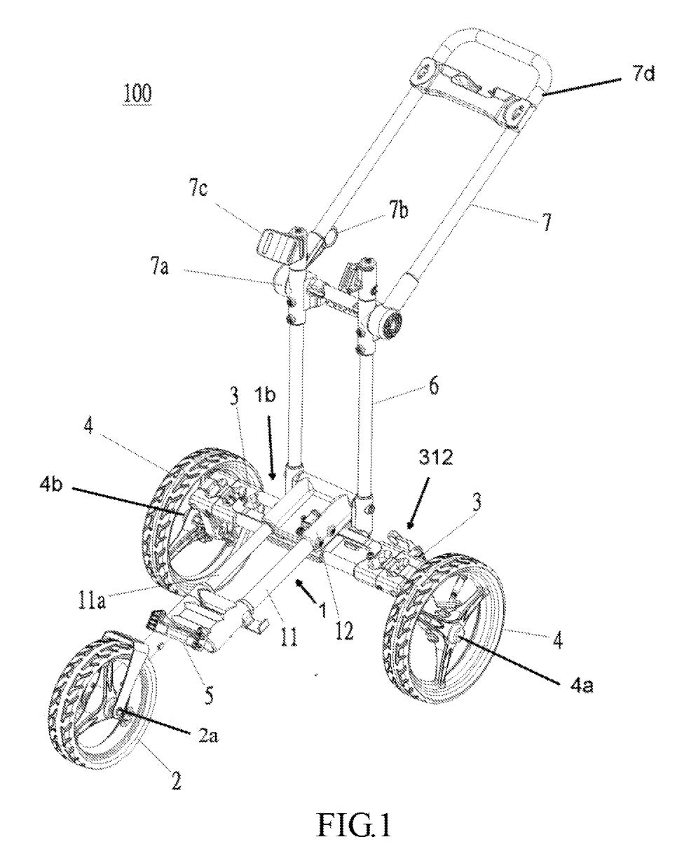

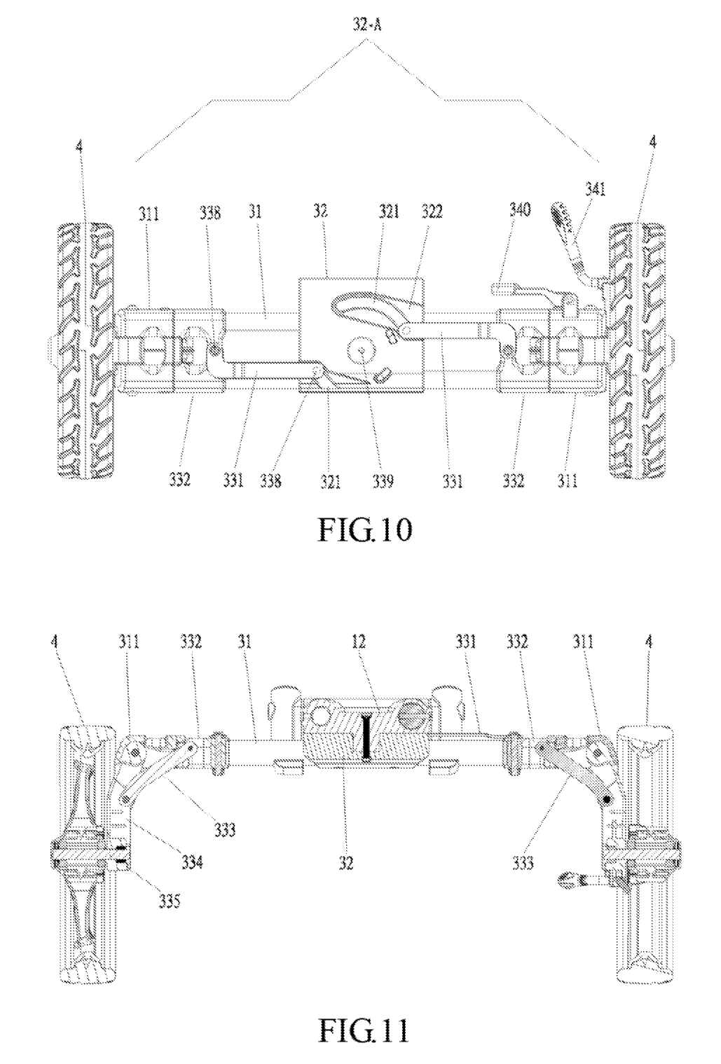

FIG. 1 shows the preferred wheeled carrier device in the fully operative position. Herein, the wheeled carrier device is a cart 100 (hereafter, the cart can be called a carrier, or a carrier device, or a device, or a cart device). In this preferred embodiment there is one front wheel and two rear wheels. It is appreciated that a different number of wheels may be utilized on the rear wheel frame or a double wheel configuration may be included on the front wheel frame. The carrier includes a front wheel frame 1 to which at least a front wheel 2 is attached, and the front wheel 2 is mounted along a retractable and extensible front wheel movable arm 51, as explained below. The wheeled carrier includes a rear wheel frame 3 which is movably secured to the front frame mounting bracket 12, with a rear frame mounting bracket 32 (shown more clearly in FIG. 11). As explained in other figures, the rear wheel frame 3, is movably mounted to the underside of the front frame mounting bracket 12 and the rear wheel frame 3 includes a swiveling assembly 32-A (see FIGS. 10 and 11 for full detail) so that the rear wheel frame 3 and the rear wheels 4, for stowing purposes, swivel for 90 degrees, and the swiveling motion synchronously also folds each of the rear wheels 4 into a compact figuration where the rear wheels 4 and the rear wheel frame 3 are stowed parallel with the other front frame components and each wheel's axis of rotation 335 is also in a parallel configuration with the front wheel frame 1. In the operative position, all of the wheels of the carrier device and their axis of rotation are orthogonal to the front wheel frame 1. The device includes an upper frame 8 which includes a handle (any suitable part of the terminal portion of the upper frame 8 may serve as a handle gripping portion or portions), and the upper frame 8 may include two separate stages, a lower stage of the upper frame 6 and an upper stage of the upper frame 7, and the device can further include an upper frame connection joint 7a, which is secured and released by any suitable latching structure, shown as the upper frame adjustment means 7b. Any suitable cargo retaining means may be included as a part of the upper frame 8, here shown as the upper frame cargo retaining means 7c for example, which may include a flexible strapping system although any securing means may be employed. Additionally, it is noted that the upper frame 8 is maintained in the upright position by a gravitational connection between a portion of the lower stage of the upper frame 6 and a portion of the rear wheel frame 3, because the preferred position of the upper frame 8 is inclined away from the center point of the device, and any suitable shape may be included on the lower stage of the upper frame in order to retain the contact between the lowest portion of the lower stage of the upper frame and a portion of the rear wheel frame 3. Any additional suitable cargo retaining means may be included along the front wheel frame 1, for example as shown as the front frame cargo retaining means 5. This may take the form of any suitable protrusion or flexible fabric may be included to assist with retaining cargo, luggage or any other attachment that holds cargo or even a portion of a baby stroller inserted into a receiving portion of the device that may retain a child or baby.

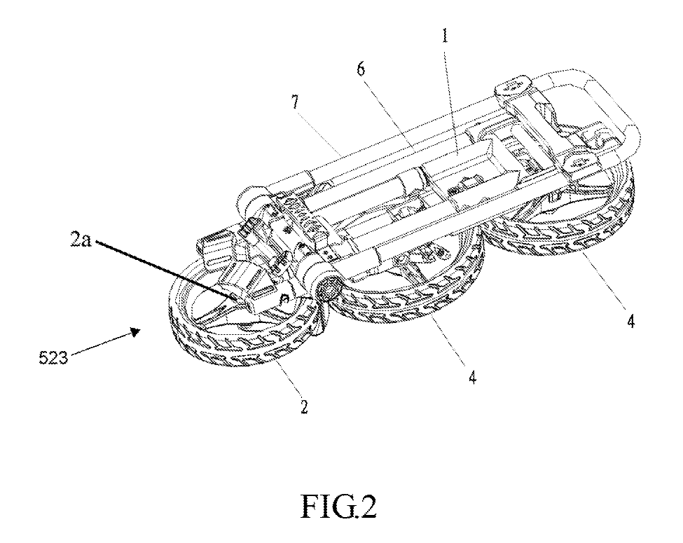

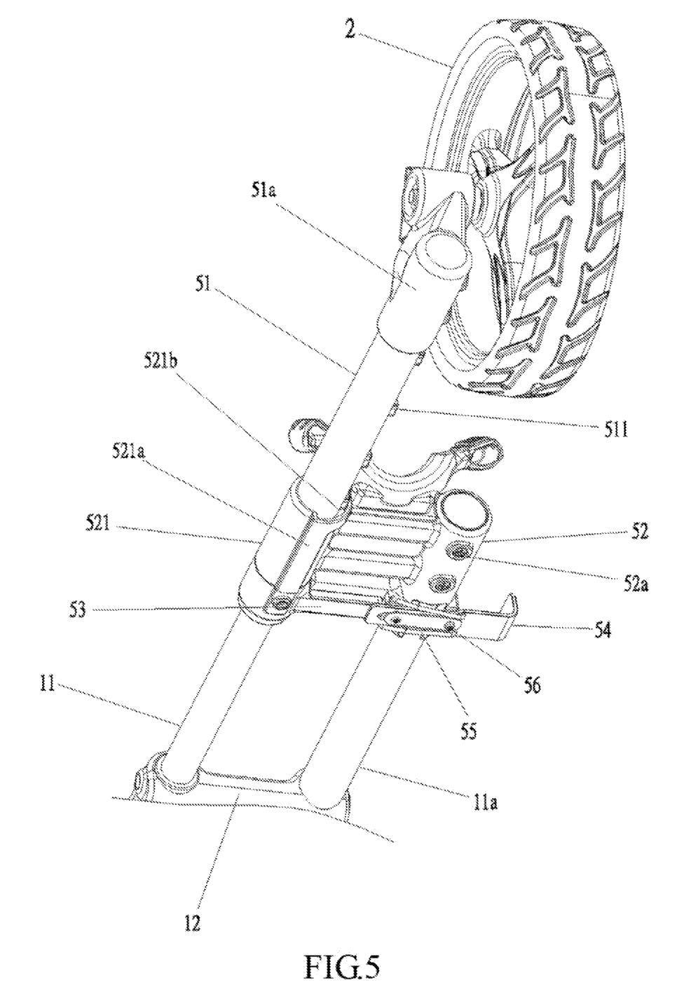

FIG. 2 is a top plan view of the fully folded wheeled cargo carrier 100 where the lower stage of the upper frame 6 and the upper stage of the upper frame 7 have been released and are folded flat into a parallel profile along with the front wheel frame 1, creating a single side elevational profile of the compact, stowed product. As shown in greater detail in other figures below, the front wheel 2 mounted on the front wheel movable arm 51 has been unlatched from its secured position and rotated along the front frame arm 11 of the fixed position, preferably for 90 degrees, and then by virtue of a series of guide way protrusions or recesses (see FIGS. 5 to 7), the front wheel movable arm 51 slides into a front wheel bracket shaped guide channel 521 that is formed as a portion of the front wheel mounting bracket 52 which permits retraction of the front wheel 2 for stowing purposes.

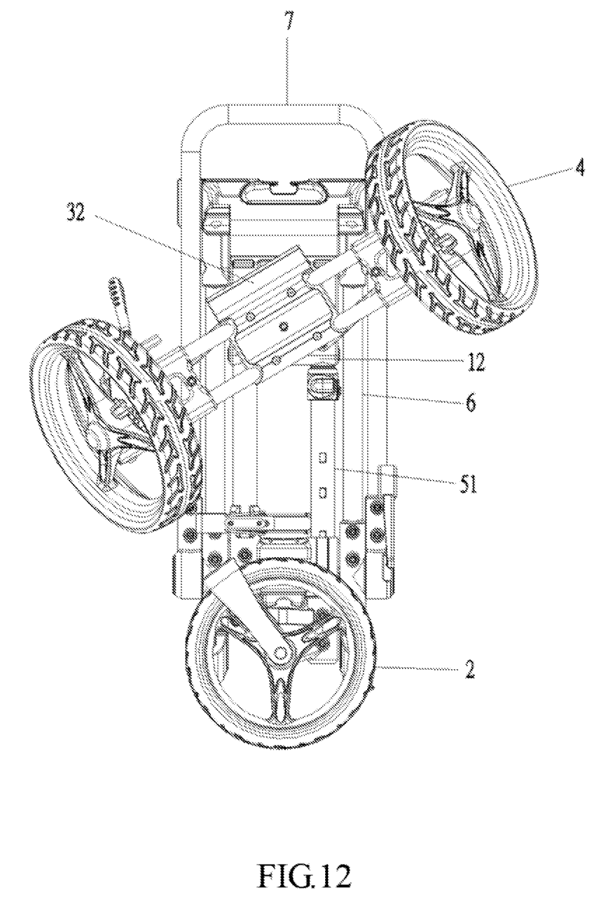

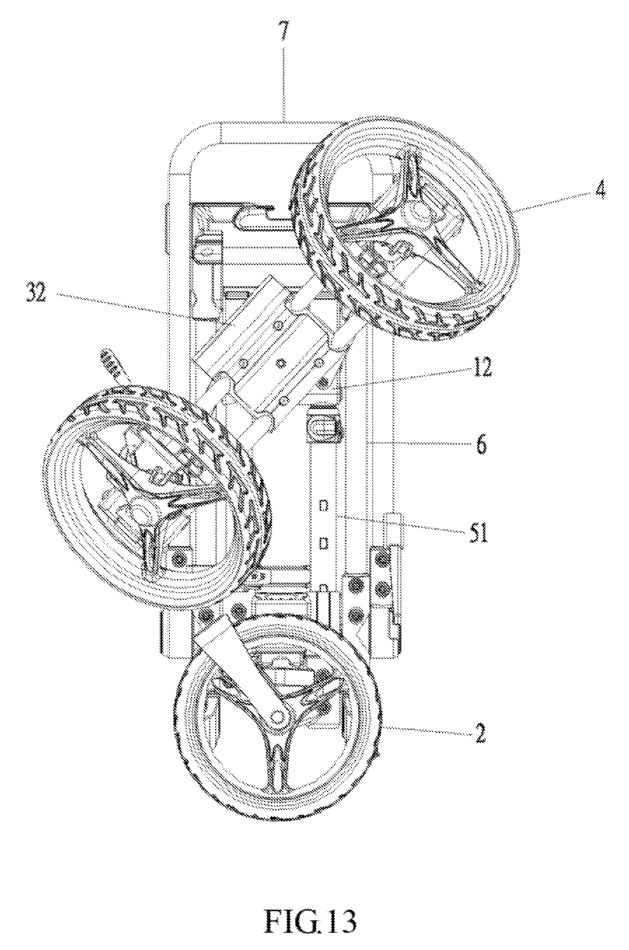

As shown in further detail elsewhere, to achieve the fully stowed position shown in FIG. 2, the fully operative rear wheels 4 and the rear wheel frame 3 are swiveled preferably for 90 degrees in a counterclockwise motion and this motion synchronously begins to turn each of the rear wheels 4 and the rear wheel frame 3 from a position perpendicular to the front main frame, (not shown in this figure but shown more clearly in FIG. 10) the wheels and the rear wheel frame 3 begin to swivel to turn (see FIGS. 12 and 13 showing intermediate swiveling positions) to the position parallel with the front wheel frame 1 as shown in FIG. 2, where the rear wheel frame 3 and both rear wheels 4 are co-planar with the front wheel 2 in a fully compact status of the device.

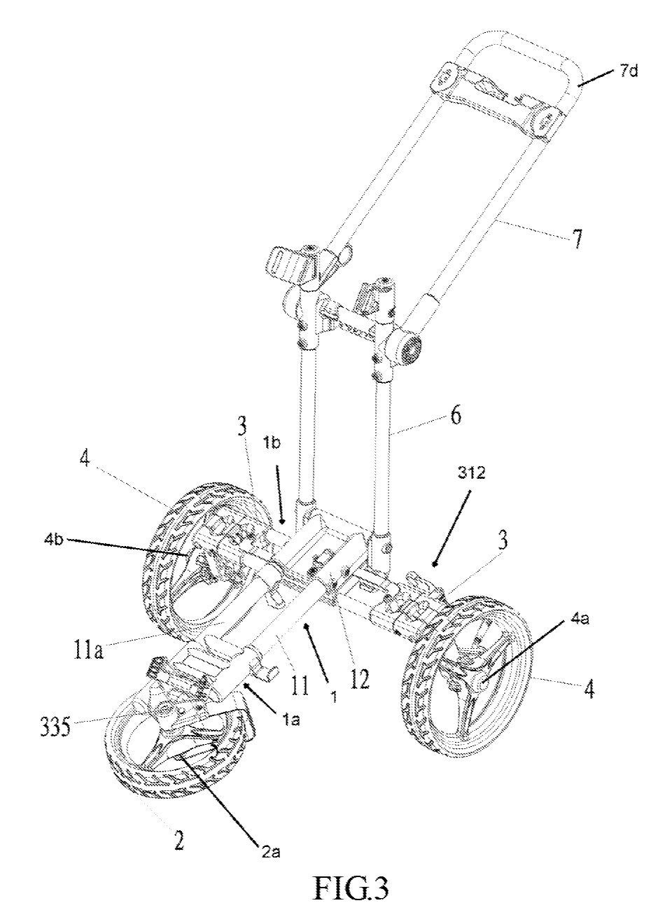

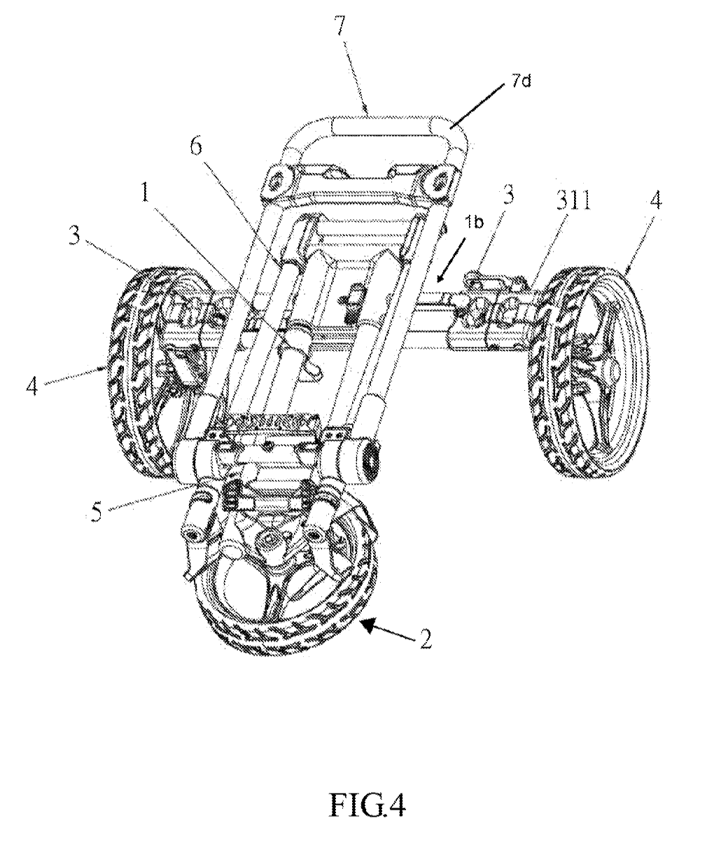

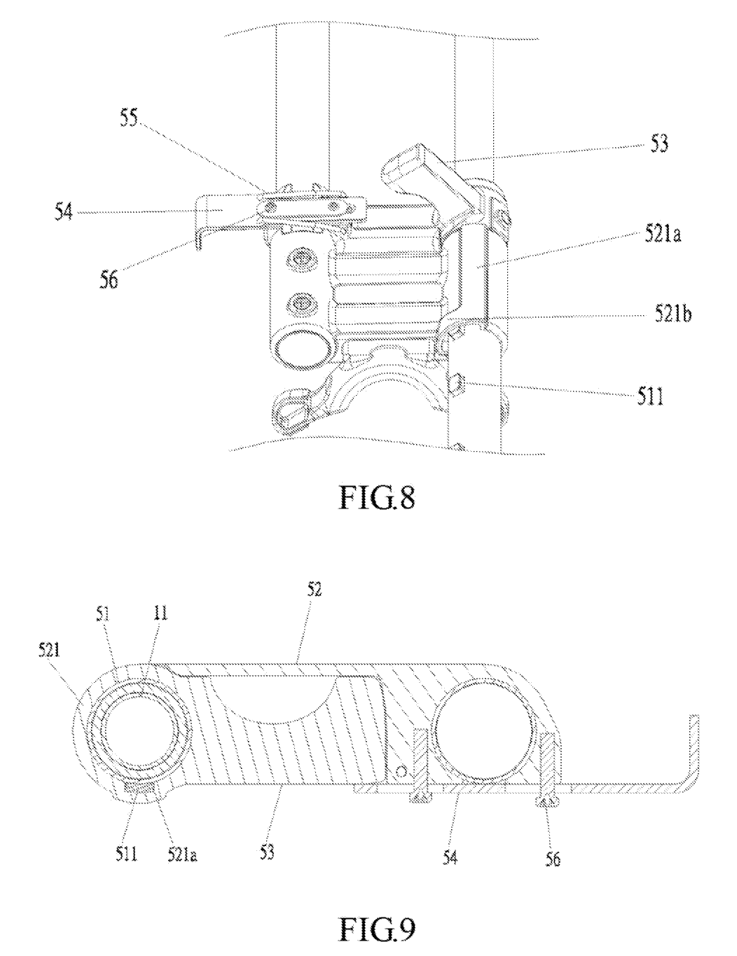

FIG. 3 is similar to FIG. 1 except that the front wheel 2 has been released from its secured position by virtue of the user manipulating a manually manipulable latch 54 (See FIG. 5) which allows the rotation of the front wheel 2 for preferably 90 degrees. Once the user turns the front wheel 2 for 90 degrees, it may be retracted within and through a front wheel bracket shaped guide channel 521 formed as a part of the front wheel mounting bracket 52 and further along a shaped portion of the front wheel frame that the preferably tubular front wheel movable arm 51 then travels over (travels around and over a portion of the fixed front wheel arm 11) to achieve the fully retracted stowed position shown here in FIG. 3. The details of the manner in which the front wheel 2 is released, and travels down a guide channel, to the fully stowed position, is detailed in FIGS. 4 to 9 discussed later.

In FIG. 4, and in conjunction with FIG. 3, the wheeled carrier device 100 shows that two stages of the upper frame 6 and 7 have been released by using the upper frame adjustment means 7b which releases the upper frame connection joint 7a between the upper stage 7 and the lower stage 6 of the upper frame allowing the lower stage 6 to move downwardly in the direction of the front wheel 2, and next in sequence the upper stage 7 folds to the collapsed status of the upper frame 8 so that it is stowed parallel with and in the side elevational profile along with the front wheel frame as shown in FIG. 4.

FIGS. 5 to 9 show the details of the mounting of the front wheel movable arm 51 along the front wheel frame 1 and the method by which the front wheel 2 is extensible and retractable. Referring first to FIG. 5, the front wheel 2 is secured to the fixed front wheel movable arm 51 by virtue of a front wheel fixing mount 51a. The front wheel 2 is extensible and retractable along the fixed front wheel movable arm 51 which travels through a front wheel bracket shaped guide channel 521 that forms a shaped opening portion of the front wheel mounting bracket 52. The front wheel bracket 52 is secured to at least one shaped portion of the front wheel frame 1 by at least one front wheel mounting bracket fixing means, 52a. Also a portion of the front wheel mounting bracket 52 includes a shaped recess (of course any suitable male/female system may be utilized; e.g., rather than a recess it may be a protrusion interaction with the front wheel movable arm 51). In this preferred embodiment of a latch, the manually manipulable latch 54 moves by means of resilient tension created by any suitable flexible material which resiliently retains the manually manipulable latch 54, urging it towards the center point between the two front frame arms 11 shown in FIG. 5. A manually manipulable portion of the manually manipulable latch 54 is secured to a portion of the front wheel frame as shown as the latch resilient retaining means 55. A portion of the fixed front wheel movable arm 51 is retained in a suitable receiving portion of the front wheel mounting bracket 52 as shown as at the front wheel arm securing means 53 in FIG. 5. When the user manually manipulates the manually manipulable latch 54 and frees the front wheel arm securing means 53 connected to the front wheel movable arm 51 by rotating the front wheel for 90 degrees, a series of protrusions, the front wheel arm male-female guides 511, along an aligned plane along the front wheel movable arm 51 are then oriented into an alignment that allows the front wheel movable arm 51 to be retracted inward toward the center point of the device. There are at least two specially shaped portions of the front wheel mounting bracket 52 that permit the extension and retraction of the front wheel movable arm 51.

Referring to FIG. 9, the front wheel arm securing means 53 are shown in a secured position within a receiving portion of the front wheel mounting bracket 52. Also FIG. 5 shows the manually manipulable latch 54 and the front wheel mounting bracket securing means 56 and how a portion of the manually manipulable latch 54 retains the front wheel arm securing means 53 until the manually manipulable latch 54 is retracted, which allows this front wheel movable arm 51 the front wheel arm securing means 53 to be rotated preferably 90 degrees in preparation for retraction of the front wheel movable arm 51 also shown in FIG. 9. The front wheel movable arm 51 travels inside a shaped portion of the mounting bracket shown at the front wheel bracket shaped guide channel 521a. A series of protrusions along the front wheel movable arm 51 are noted as 511 in FIG. 9 and are also clearly shown in FIG. 5.

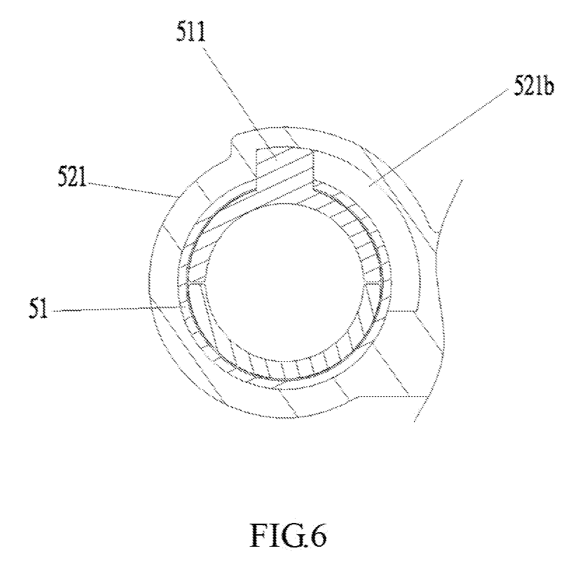

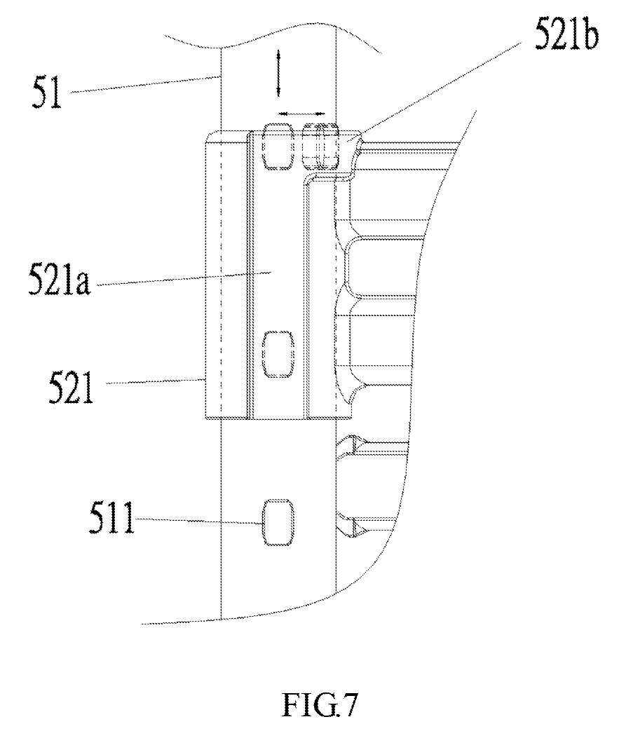

A series of guide channels are shown in FIGS. 6 and 7 that guide the extension/retraction and rotation of the front wheel movable arm 51. Once the front wheel 2 is released from its secured position and rotated for 90 degrees, the series of front wheel arm male-female guides 511 must be oriented into alignment with the front wheel mounting bracket movable wheel arm receiving means 521b as shown in FIG. 7 in order to successfully retract the front wheel movable arm 51. After the rotation above mentioned, the front wheel movable arm 51 is retracted through the shaped portion of the front wheel bracket shaped guide latching channel at 521a, and the series of front wheel arm male-female guides 511 retain the front wheel 2 in the folded orientation as shown in FIG. 4. This retraction and extension orientation is shown in FIG. 7 and prevents the user from accidentally or improperly turning the stowed wheel in any fashion except to retract it in the stowed position (it is appreciated that the system can be reversed and that there can be recesses along the front wheel movable arm 51, and protrusions may be formed in a guide way or guide path channel). In extending the front wheel 2 from the stowed position the user can only move and extend the front wheel 2 and the front wheel movable arm 51 along the same plane the wheel was in when it retracted, to return it to the fully operative position and, in addition, the user cannot turn the front wheel 2 for 90 degrees back to the operational position until it is fully extended. The same channel and male/female protrusions that travel inside the front wheel bracket shaped guide latching channel 521a prevent the front wheel 2 from being placed in the operative position where it is orthogonal with the front wheel frame until it is fully extended, at that point the front wheel movable arm 51 is rotated which allows at least one front wheel arm male-female guides 511 to rotate in the front wheel mounting bracket movable wheel arm receiving means 521b which is isolated in FIGS. 6 and 7. Only when fully extended, can the front wheel movable arm 51 be turned 90° and then a portion of that movable front wheel arm, shown at 53, rotates into the front wheel arm securing means 53 that further secures and latches the front wheel 2 against unintended movement.

FIG. 10 is the first figure detailing a new state of the art innovation of the swiveling rear wheel frame 3 and the method by which a swivel assembly 32-A permits both of the rear wheels 4 and the rear frame mounting arm 31 to be synchronously moved along the rear frame mounting bracket 32, counterclockwise 90 degrees, to achieve a fully stowed position of the rear wheels 4. Referring to FIG. 10, the drawing shows a rear frame mounting bracket 32 which is movably secured to the front wheel frame mounting bracket 12 by virtue of a swivel assembly securing member 339, which interconnects the rear frame 31 and the overall swivel assembly 32-A to the bottom portion of the front frame mounting bracket 12 (only partially shown in FIG. 10) This rear frame mounting bracket 32 movable mounting method permits the entire rear wheel frame mount, including the at least two rear wheels 4 to swivel at least 90 degrees along the rotatable or swiveling mounting means 39. Moving left and right from the central rear frame mounting bracket 32 in FIG. 10, a set of at least two swivel assembly linkages 331 connected by securing means 338 to the rear frame mounting bracket 32, and connected at the opposite end of the swivel assembly linkage 331 to a rear frame slider 332, wherein the rear frame sliders 332 are slidably mounted along the rear frame mounting arm 31. Referring also to FIG. 11, the pair of rear frame sliders 332 of the rear wheel frame 3 are further connected by a rear wheel movable linkage 333 which interconnects the rear frame slider 332 to the rear wheel mounting axle 334. Each of the rear wheels 4 are mounted to the rear wheel mounting axle 334 and then secured near the terminal end of the rear wheel frame 3 by a rear frame wheel mount 311.

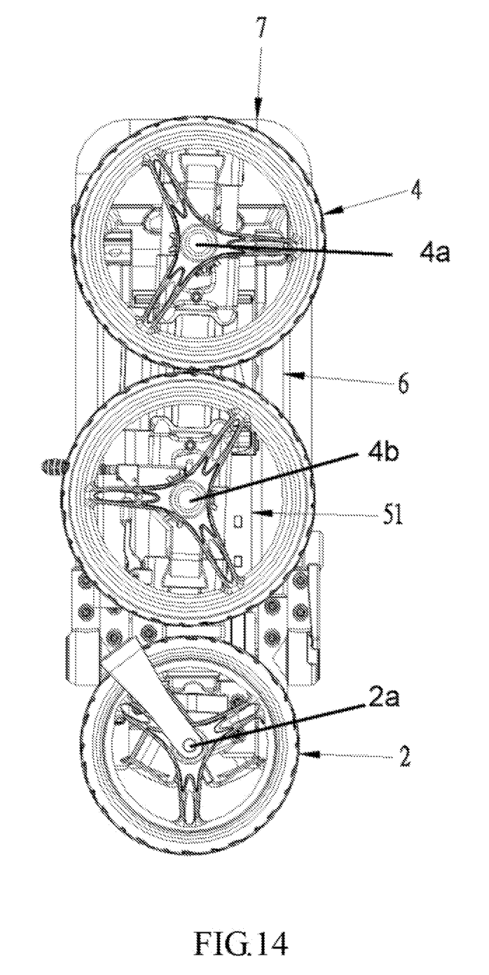

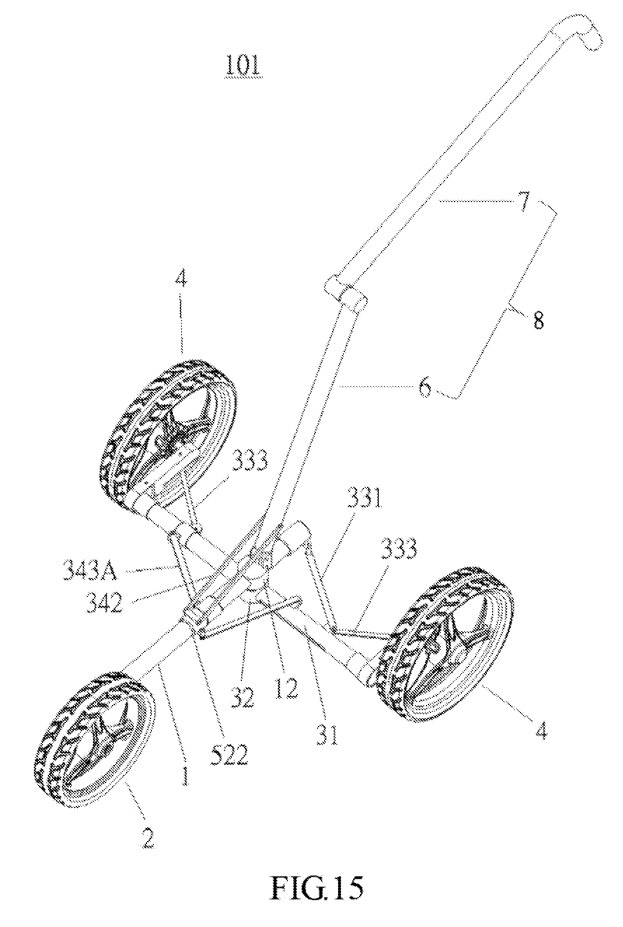

Referring to both FIG. 10 and more particularly to FIG. 11, swiveling the rear frame mounting arm 31 preferably 90 degrees, causes the swivel assembly linkage 331 to pull the rear frame slider 332 inwards toward the center point along the rear wheel frame 3, and this synchronously also pulls inwards the rear wheel movable linkages 333 which are in turn also interconnected to the rear wheel axle 334, to which the rear wheels are interconnected. Accordingly, as the rear wheel frame 3 is swiveled preferably 90 degrees, each of the rear wheels 4 are thereby drawn in from the orthogonal position shown in FIG. 11 to the intermediate positions shown sequentially in FIG. 12, and then FIG. 13, where each of the rear wheels 4 are partially moved inwards toward the center point of the rear frame mounting arm 31, and then to the completely stowed position showed in FIG. 14.

In a completely stowed position, the front wheel and the rear wheels 4 are linearly aligned with one another; and the front wheel axle 20 (axis of rotation) is parallel with both rear wheel axles 4a, 4b (axis of rotation).

Additionally, as shown in FIG. 10, rather than manually grasping either rear wheel 4, to move the rear wheels 4, the user may manually use a rear frame swiveling finger grip 340 to assist in the swiveling motion of the rear wheel frame 3 to avoid the user having to actually handle or touch the rear wheel 4. Both FIGS. 2 and 14 show the fully compact stowed status of the wheeled carrier device whereby all of the wheels of the device are co-planar, closely contiguous to and parallel with the front wheel frame and the upper frame 8 in its folded compact status.

Although previously explained, and referring to all the previous figures, in order to fold and stow the carrier device the user follows this order of steps: fold down the handle on to the front wheel frame 1, unlatch the front wheel 2, rotate it 90 degrees, move it inwards fully, and finally swivel the rear wheel frame 3 and wheels 90 degrees, preferably using the finger grip which synchronously moves both the rear wheel frame 3 and rear wheels 4 to the stowed position. This motion orients the at least three device wheels in a co-planar orientation, and parallel with the front wheel frame, and with the rear wheel frame 3 and the upper frame stages all parallel with each other forming a compact side elevational profile. To unfold, the steps above are reversed. In the compact fully stowed carrier device status, the three wheel's axis of rotation are oriented substantially below the front wheel frame 1 and upper frame and are parallel with said frames, and each of said wheels axis of rotation are substantially aligned co-planar with each other.

FIG. 15 shows alternative foldable wheeled cart device 101 which is a more simplified embodiment of the carrier cart than device 100. Device 101 attains many of the fully stowed features similar to device 100, however, activation of the folding and unfolding process is accomplished differently. In the embodiment of device 101, movement of the front wheel frame for 90 degrees in one latitudinal direction activates the synchronous folding of the rear wheels 4, whereas the embodiment of the cart 100 instead retracts the front wheel 2 and front wheel frame 1 inwards towards the rear wheel frame 3, and separate manual swiveling movement of the rear wheel frame 3 causes the synchronous folding of the rear wheels 4. Accordingly, in the device 101, latitudinally moving the front wheel frame 1 in one 90 degree direction moves the at least one front wheel 2 and the rear wheels 4 into a co-planar folded profile, and reversed motion serves to setup the rear wheels 4 and at least one front wheel 2. In the cart device 101, all the stowed wheels and their axis of rotation are co-planar and linearly aligned, closely adjacent to the front wheel frame 1, the rear wheel frame 3 and the upper frames 8 in a single side elevational profile.

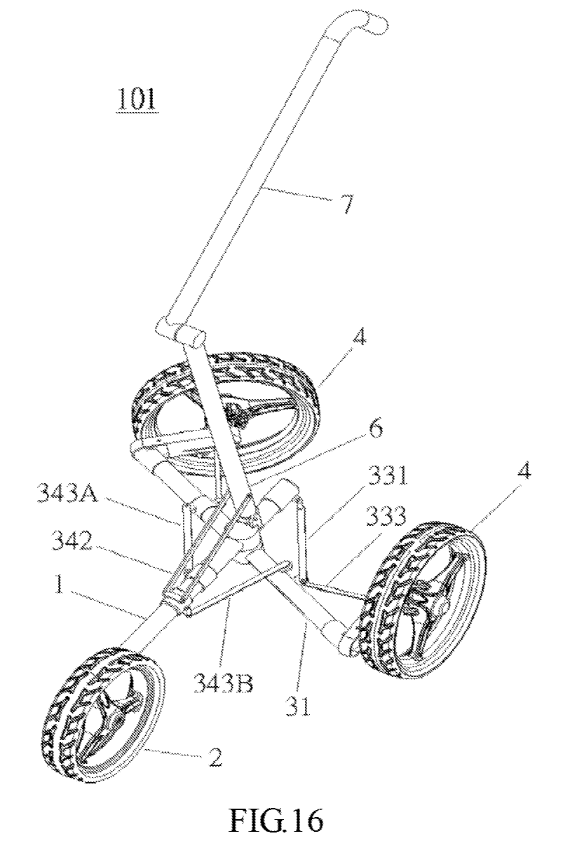

FIG. 15 shows the carrier in the fully operative position showing a front wheel frame 1 to which at least one front wheel 2 is attached, as well as a rear frame mounting arm 31 to which rear wheels 4 are movably mounted. Although a different number of stages may be included, FIG. 15 depicts an upper frame 8 which includes a lower stage 6 and an upper stage 7 and the upper most terminal portion of the upper stage 7 forms a push/pull handle grasp. In alternative carrier cart 101, the series of linkages previously described in the application work similarly, but there are some differences, which can best be seen in the folding process shown in FIG. 16. As the stages of the handles 6 and 7, forming a part of the upper frame 8, are folded in a forward direction toward the operative front wheel 2, a series of linkages 342 interconnect between the upper frame 8, lower stage 6, and a front frame slider ring 522. The front frame slider ring 522 is mounted around the periphery of the front wheel frame 1 and includes interconnected linkages between the front wheel frame 1 and the rear frame mounting arm 31.

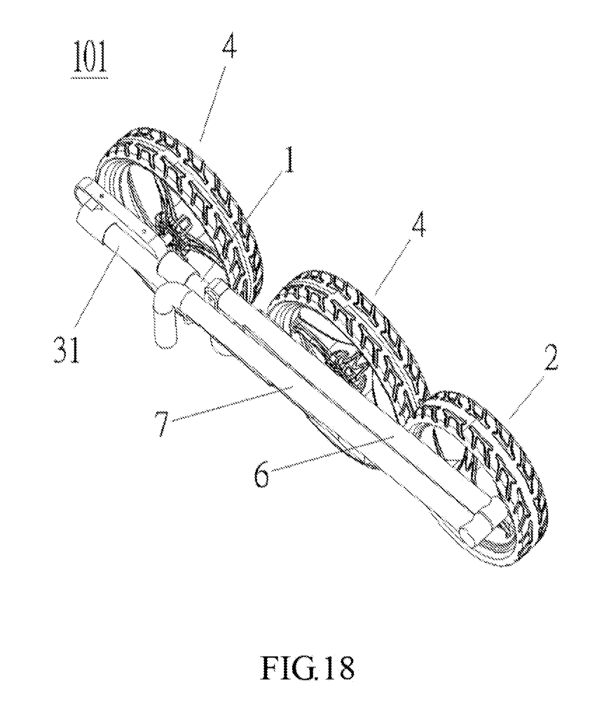

As seen in FIG. 16, as the upper frame 8 handle folds forward, the multiple linkages 342 move a front frame slider ring 522 along the upper frame, and one linkage between the slider ring interconnects to the rear frame mounting arm 31 as seen at first linkage 343A. A second linkage 343B connects between the front frame slider ring 522 and portions of the rear frame mounting arm 31. The aforesaid interconnected linkages force rotation of the front wheel frame 1 in a counter-clockwise direction (as depicted in FIG. 16) ultimately rotating and swiveling the front wheel 2 to the fully stowed co-planar position with the other wheels of the device, as shown in FIG. 18, where the front wheel 2 and each of the rear wheels 4 are folded co-planar and parallel with the rear frame mounting arm 31. The front wheel frame 1 and the two stages of the upper frame 6 and 7, are also in a parallel stowed configuration with the aforesaid wheels as shown in FIG. 18. Of course, alternatively the front wheel frame 1 and the linkages can alternatively be organized to have the front wheel frame 1 instead fold clockwise (not shown). Referring to FIGS. 15 to 17, these figures show how other linkages synchronously fold the rear wheels 4 into their fully stowed configuration as well. As the front wheel 2 and the front wheel frame 1, move counter-clockwise during the folding process, as shown in FIG. 15, the first linkage 343A is interconnected, along the rear frame mounting arm 31 to a rear wheel movable linkage 333. As the front wheel frame 1 and front wheel 2 move toward the fully stowed position by virtue of the movement of the upper frame stages 6 and 7, this movement also pulls the first linkage 343A which is further interconnected to the rear wheel movable linkage 333 which synchronously folds one of the rear wheels 4 between the operative position shown in FIG. 15, to the intermediate position shown in FIG. 16, and then fully folding it to the stowed position in FIG. 18. Likewise, the counter-clockwise folding motion of the front wheel frame 1 causes the other rear wheel 4 to fold in the following manner: a portion of the front wheel frame 1 extends in a rearward direction past the transverse intersection with the rear frame mounting arm 31. Another swivel assembly linkage 331, mounted near the rear terminal portion of the front wheel frame 1 links to a mounting slot along the rear frame mounting arm 31 (slot not shown in FIG. 16). The swivel assembly linkage 331 is interconnected to a rear wheel movable linkage 333 which interconnects with the rear wheel 4 as shown in FIG. 16. As the counter-clockwise motion of the front wheel frame 1 moves from the operative to the stowed position, the counter-clockwise motion of the rear of the front wheel frame 1 pulls on the swivel assembly linkage 331, and its interconnection to the rear wheel movable linkage 333, which moves at least one rear wheel 4 from the operative position towards its stowed position as shown in FIG. 18.

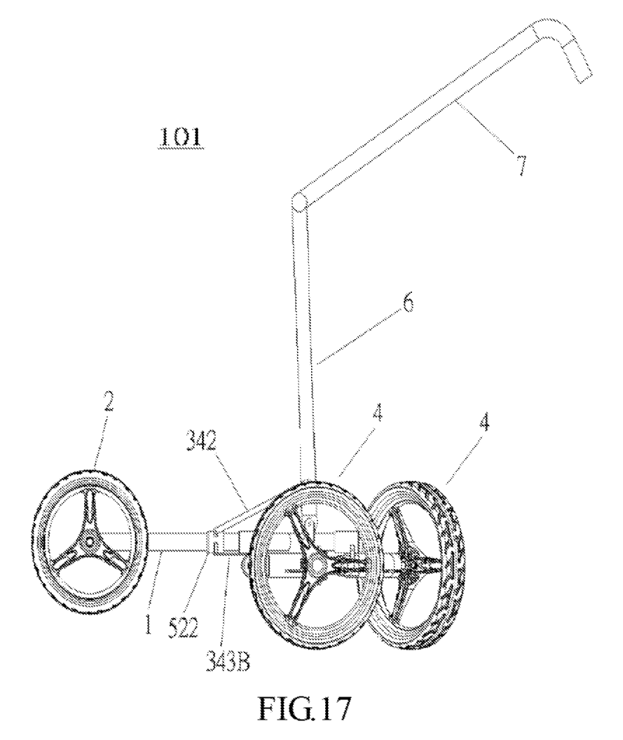

FIG. 17 shows a side elevational view of the carrier 101, providing a different perspective of the linkage from the lower stage of the upper frame 6 to the front wheel frame 1 which is accomplished by a multiplicity of linkages 342 that are mounted to a front frame slider ring 522 which is slidably mounted along the front wheel frame 1. As shown in FIG. 17, when the lower stage of the upper frame 6 is moved forward, and the linkage 342 slides toward the front wheel 2, the interaction of the series of linkages above explained, forces the rear wheels 4 toward their stowed positions in a synchronous fashion and, the front wheel 2 mounted on the front wheel frame 1 also folds from the front position, counter-clockwise, towards the fully stowed position shown in FIG. 18.

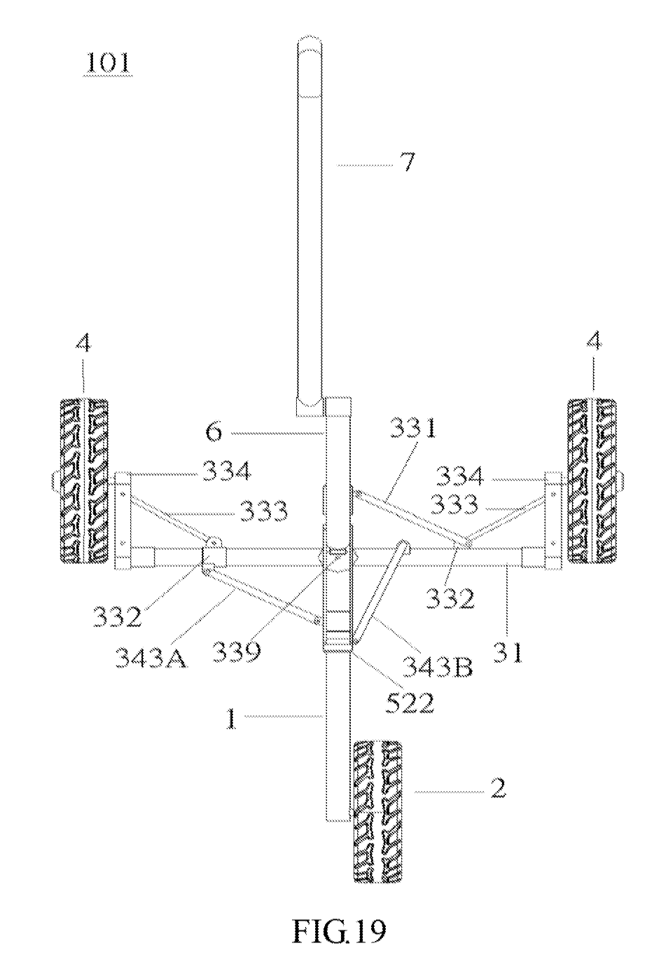

FIG. 19 is a top plan view of the fully operative carrier device 101, and the linkages can be seen more clearly here. The first linkage 343A connects the front frame slider ring 522 to one of the rear wheel movable linkages 333 which interconnect with the rear wheel mounting axle 334 and the rear wheel 4. In order to accomplish the innovation described in carrier 101, the other side linkages are slightly different to accomplish the folding motion, and therefore the second linkage 343B interconnects between the front frame slider ring 522 and portion of the rear frame mounting arm 31.

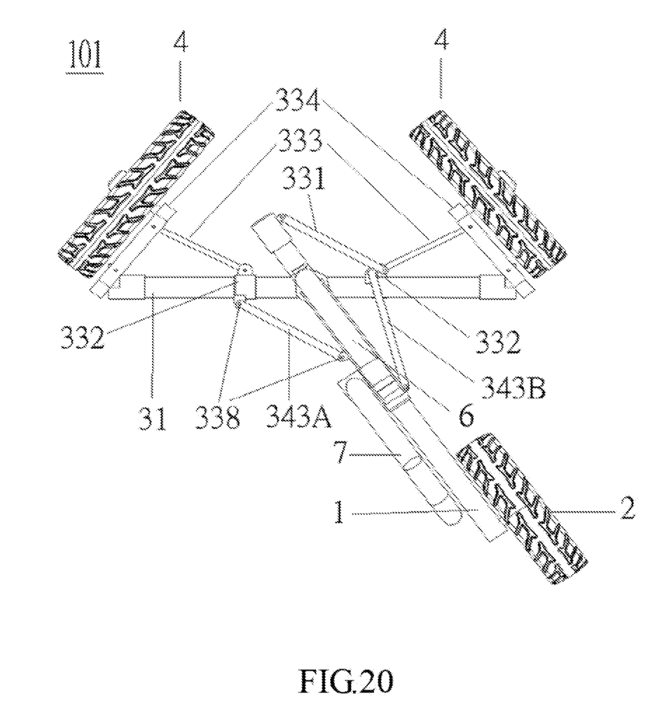

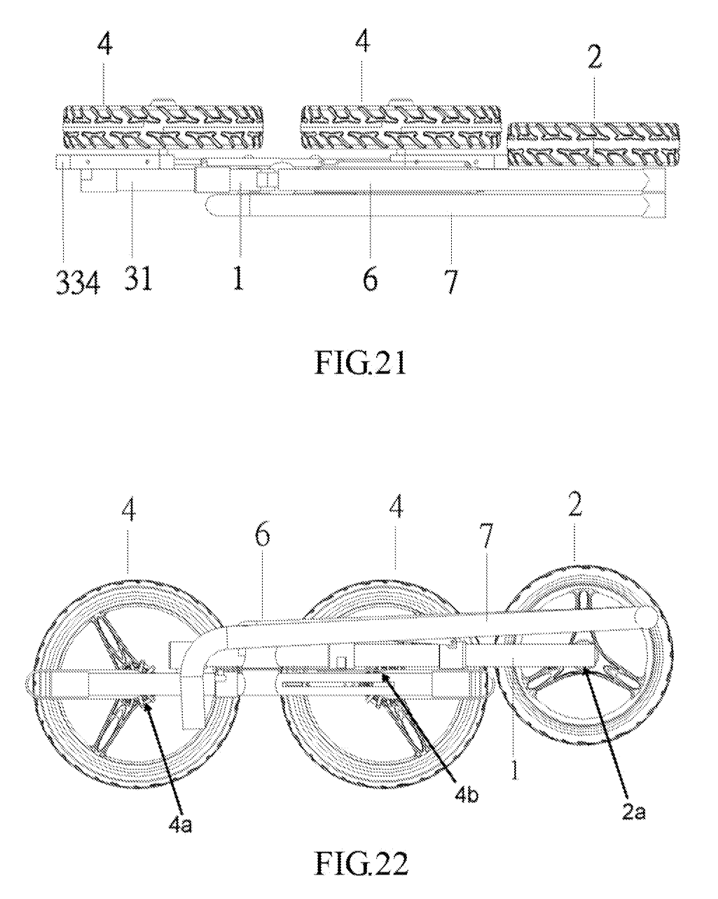

Referring to FIG. 20, which shows the intermediate folding position of the wheels, the front wheel frame 1 is partially folded counter-clockwise towards the stowed position of the front wheel 2. During this motion it can be seen that the first linkage 343A interconnects to the rear frame mounting arm 31 and to a rear frame slider 332, which is slideable along the rear frame mounting arm 31. As the rear frame slider 332 pulls toward the center point of rear frame mounting arm 31, it interconnects with the rear wheel movable linkage 333 which serves to pull one of the two rear wheels 4 towards its stowed position. FIG. 20 shows that on the other side of the rear frame mounting arm 31, the interconnected linkages are slightly varied from the other side. The front frame slider ring 522, during the counter-clockwise folding motion of the front wheel frame 1, pulls forward toward the front wheel 2 and a linkage is connected to the slider along the front wheel frame 1 at the second linkage 343B which connects to the rear frame mounting arm 31. However, also as seen in FIG. 20, a rearward facing stub portion of the front wheel frame 1 has another linkage at the swivel assembly linkage 331 connecting near the terminal rear end of the front wheel frame 1, specifically to a sliding or recessed area along the rear of the rear frame mounting arm 31 (although the sliding recess is not shown clearly in FIG. 20). The counter-clockwise motion of the rear portion of the swivel assembly linkage 331 is interconnected with the rear wheel movable linkage 333, which is further connected to the other rear wheel 4, and as the front wheel frame 1 is turned in the counter-clockwise motion, this causes the rear wheel 4 to move toward the fully stowed position which is shown in FIG. 21.

Referring to FIGS. 19 to 22, the movement between these figures demonstrates that the upper stage of the upper frame 7 has at least one joint connecting it to a lower stage of the upper frame 6 and referring back to FIG. 16, the intermediate position of the upper frame 8 parts are shown at the beginning of the folding motion from the operative position towards the stowed position. In the embodiment the cart 101, the joint between the lower and upper stages of the upper frame moves toward the front wheel 2 mounting position, as the parts are folded, placing the fully folded upper frame connecting joint close to the stowed position of the front wheel 2. The handle grasp of the upper stage 7, is adjacent and contiguous to the rear wheels 4 when in the folded and stowed position. This can be seen more clearly in FIGS. 21 and 22.

To unfold the cart 101 from the fully stowed position shown in FIGS. 21 and 22, the movement essentially is the reverse of that described above which accomplishes the unfolding synchronously, so that each of the wheels are moved from the fully stowed position shown in FIGS. 21 and 22 to the fully operative position shown in FIGS. 15 and 9.

In the stowed position e.g. (FIGS. 21 and 22), the front wheel axis 20 and rear wheel axes 4a, 4b are substantially parallel to each other and front wheel 2 and rear wheels 4 are substantially linear with each other.

It is appreciated that a different number of wheels may be utilized without departing from the spirit of this disclosure. It is also appreciated that the inwards movement of the front wheel arm in the embodiment of the cart 100 may take on various shapes and orientations (including other folding methods, rather than extending and retracting), or that this may be accomplished by tubular or rectangular shapes of the extension and retraction channel and arm. Also, any suitable latching method may be utilized to retain the front wheel arm of the embodiment of the cart 100 in its operative, or in the stowed compacted position, and a different latching method may be employed. With regard to the upper frame stages 6 and 7 of embodiment the cart 100, it is appreciated that an extensible and retractable upper frame 8 may be included, where a single plane is utilized and a portion of the frames extend and retract in a single plane, rather than two separate stages of the upper frame 8 with a movable joint as disclosed in this application. Further, without departing from the innovation of the movable rear wheel frame 3 (in either embodiment of the cart 100 or the cart 101) it is appreciated that different folding or motion methods may be employed that accomplish the main purpose of moving the rear wheel frame 3 and the at least two rear wheels 4 to the alignment which moves the rear wheel frame 3 adjacent to the front wheel frame 1, parallel with the front wheel frame 1 and which causes the rear wheels 4 to be folded co-planar with the front wheel 2, whether by swivel, rotation, or manual manipulation of the rear wheel frame 3 and the rear wheels one at a time rather than synchronously.

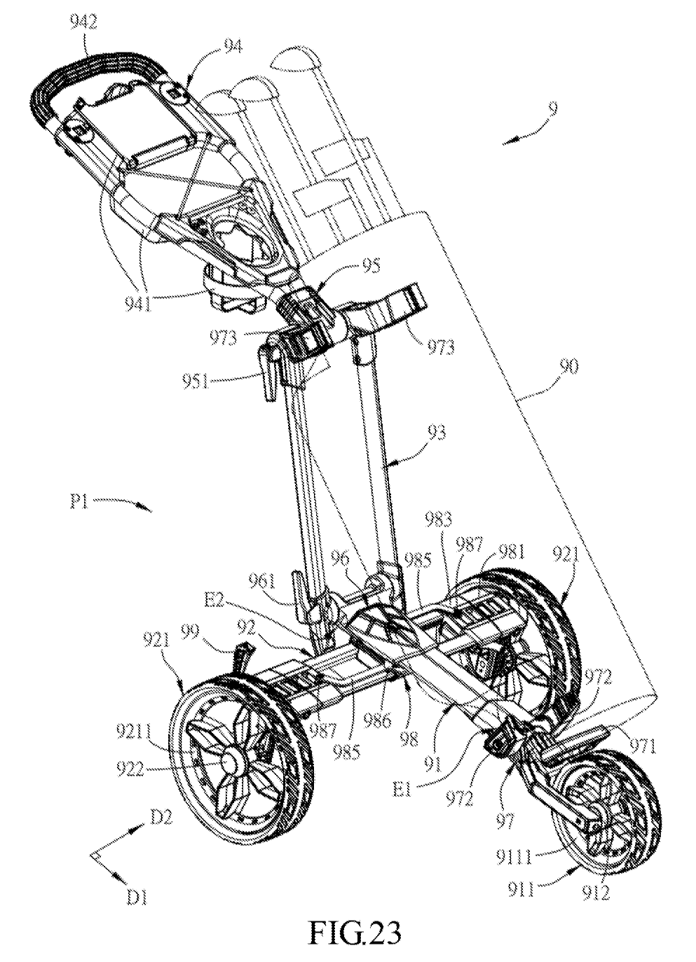

Moreover, FIG. 23 is a schematic diagram of a carrier device 9 of another embodiment of the disclosure. The carrier device 9 is a wheeled foldable cart, which is, for example but not limited to, a golf cart, a baby carriage, a shopping cart, or other wheeled foldable carts. Herein for example, the carrier device 9 is a golf cart. The detailed structure of the carrier device 9 will be described first as below, and then the folding and stowing processes thereof will be described.

As shown in FIG. 23, the carrier device 9 includes a front wheel frame 91, a rear wheel frame 92, an upper frame 93, a front wheel 911 and a plurality of rear wheels 921. The carrier device 9 of this embodiment can further include a handle frame 94, a handle frame linkage 95, an upper frame linkage 96 and a front wheel linkage 97.

The front wheel frame 91 includes a first end E1 and a second end E2. The rear wheel frame 92 is disposed on the front wheel frame 91. Herein, the rear wheel frame 92 is connected to the front wheel frame 91. To be noted, the “connection” of this embodiment can include the types of a “movable connection” and a “immovable connection”. Physically, the rear wheel frame 92 and the front wheel frame 91 of this embodiment belong to the relatively movable connection. For example, the front wheel frame 91 can be fixed so that the rear wheel frame 92 can move or rotate with relation to the rear wheel frame 92; or the rear wheel frame 92 is fixed so that the front wheel frame 91 can move or rotate with relation to the rear wheel frame 92. In this embodiment, the front wheel frame 91 is composed of a front wheel frame arm (not labeled) and the rear wheel frame 92 is composed of two parallelly disposed rear wheel frame arms (not labeled), and the material thereof includes metal or plastic material for example, and this disclosure is not limited thereto. In the normal use and stowing situations, the carrier device 9 has an operative state and a stowing state. The operative state has an operative position P1, and the stowing state has a stowing position P2. As shown as the operative position P1 of FIG. 23 (or called the using position or the extending position), the front wheel frame 91 of the carrier device 9 can extend toward a first direction D1 and the rear wheel frame 92 can extend toward a second direction D2, which is substantially perpendicular to the first direction D1. Moreover, the plane constituted by the rear wheel 911 is substantially parallel with the plane constituted by the rear wheels 921.

To be noted, the two are called perpendicular to each other when they have an included angle of 90 degrees and called parallel with each other when they have an included angle of zero. However, the two can be called substantially perpendicular to each other when their included angle is between 85 and 95 degrees and can be called substantially parallel with each other when their included angle is between ±10 degrees, preferably between ±5 degrees. Furthermore, the plane constituted by the front wheel 911 denotes the plane formed by the front wheel rim 9111, and the plane constituted by the rear wheel 921 denotes the plane formed by the rear wheel rim 9211. As shown in FIG. 23, the front wheel 911 and the rear wheel 921 are substantially parallel with the first direction D1.

The upper frame 93 is disposed on the second end E2 of the front wheel frame 91. Herein, the upper frame 93 is connected to the end (the second end E2) of the front wheel frame 91 farther from the front wheel 911 and disposed adjacent to the rear wheel frame 92, while the upper frame linkage 96 is disposed at the junction between the front wheel frame 91 and the upper frame 93. The upper frame 93 is composed of two parallelly disposed upper frame arms (not labeled), and the material thereof includes metal or plastic material but this disclosure is not limited thereto. The upper frame 93 is movably connected to the second end E2 of the front wheel frame 91 farther from the front wheel 911, and the front wheel frame 91 and the upper frame 93 are connected to two sides of the upper frame linkage 96 respectively, so that the front wheel frame 91 and the upper frame 93 can be connected to each other by the upper frame linkage 96. Besides, the upper frame 93 can further be folded with relation to the front wheel frame 91 by the upper frame linkage 96. Physically, the upper frame 93 and the front wheel frame 91 can be connected with each other and move with relation to each other through the upper frame linkage 96. For example, the front wheel frame 91 can be fixed and the upper frame 93 can be folded toward the direction of the front wheel frame 91 through the upper frame linkage 96, and vice versa.

Moreover, the carrier device 9 of this embodiment can further include an upper frame adjustment means 961, which is disposed on the upper frame linkage 96 to control the folding movement between the upper frame 93 and the front wheel frame 91. Herein for example, the folding movement between the upper frame 93 and the front wheel frame 91 denotes the upper frame 93 is folded toward the front wheel frame 91, or the front wheel frame 91 is folded toward the upper frame 93, or the upper frame 93 and the front wheel frame 91 are made approach each other. In some embodiments, the upper frame adjustment means 961 can include a handle, a spring and a protrusion/recess structure (not shown). By loosing the upper frame adjustment means 961, the upper frame 93 and the front wheel frame 91 can have a relative folding movement by the upper frame linkage 96. Otherwise, when the upper frame adjustment means 961 is fastened, the relative position between the upper frame 93 and the front wheel frame 91 can be fixed. Furthermore, in the operative position P1 as shown in FIG. 23, the upper frame 93 or the upper frame linkage 96 can be disposed against the rear wheel frame 92, so that the rear wheel frame 92 won't rotate or move with relation to the front wheel frame 91 when the user pushes the carrier device 9.

The handle frame 94 is disposed on the upper frame 93. Herein, the handle frame 94 is connected to the end of the upper frame 93 farther from the front wheel frame 91. In this embodiment, the handle frame 94 is composed of two handle frame arms (not labeled) and a handle 942, and the material thereof includes metal or plastic material without a limiting sense, and the handle frame 94 can be movably connected to the end of the upper frame 93 farther from the front wheel frame 91. Moreover, the handle frame linkage 95 is disposed at the junction between the handle frame 94 and the upper frame 93. Herein, the handle frame 94 and the upper frame 93 are disposed on two sides of the handle frame linkage 95 respectively, so that the handle frame 94 can be folded with relation to the upper frame 93 by the handle frame linkage 95. Physically, the handle frame 94 and the upper frame 93 can be connected to each other and can move or rotate with relation to each other by the handle frame linkage 95. For example, the upper frame 93 can be fixed and then the handle frame 94 can be folded toward the direction of the upper frame 93 by the handle frame linkage 95, and vice versa. The carrier device 9 can further include a handle frame adjustment means 951, which is disposed on the handle frame linkage 95 to control the folding movement between the handle frame 94 and the upper frame 93. In the case of the operative position P1 of FIG. 23, the handle frame adjustment means 951 is fastened, so the handle frame 94 can't be folded with relation to the upper frame 93.

In some embodiments, the handle frame adjustment means 951 can include a handle, a spring and a protrusion/recess structure (not shown). By loosing the handle frame adjustment means 951, the handle frame 94 and the upper frame 93 can be folded with relation to each other by the handle frame linkage 95. When the handle frame adjustment means 951 is fastened, the relation position between the handle frame 94 and the upper frame 93 can be fixed so that both of them can't be move relatively. In the case of the operative position P1 of FIG. 23, the handle frame adjustment means 951 is fastened, so the handle frame 94 can be folded with relation to the upper frame 93. Moreover, the handle frame 94 of this embodiment can be configured with at least an object accommodating means 941, which has an accommodating space used to, for example without a limiting sense, hold a cup, a water bottle, a beverage can, golf balls, or a scorecard.

In order to fix the stuff (such as a golf bag 90) disposed on the carrier device 9 to prevent the falling when the carrier device 9 moves, the carrier device 9 can further include a front frame cargo carrier 971, at least two lower stoppers 972 and at least two upper stoppers 973. In this embodiment, the front frame cargo carrier 971 is disposed on the front wheel linkage 97 and opposite to the front wheel 911, and the two lower stoppers 972 are disposed on two sides of the front wheel linkage 97 respectively. Moreover, the two upper stoppers 973 can be disposed on the handle frame linkage 95, the upper frame 93 or the handle frame 94. In this embodiment, the two upper stoppers 973 are disposed on two sides of the handle frame linkage 95 respectively, so that the stuff disposed on the carrier device 9 can be held on the upper side and the lower side so as not to fall during the transportation. In some embodiments, the two upper stoppers 973 or the two lower stoppers 972 can be adjusted in the spreading width adaptively to accommodate and fix objects of different widths so as to avoid their falling during the operative state.

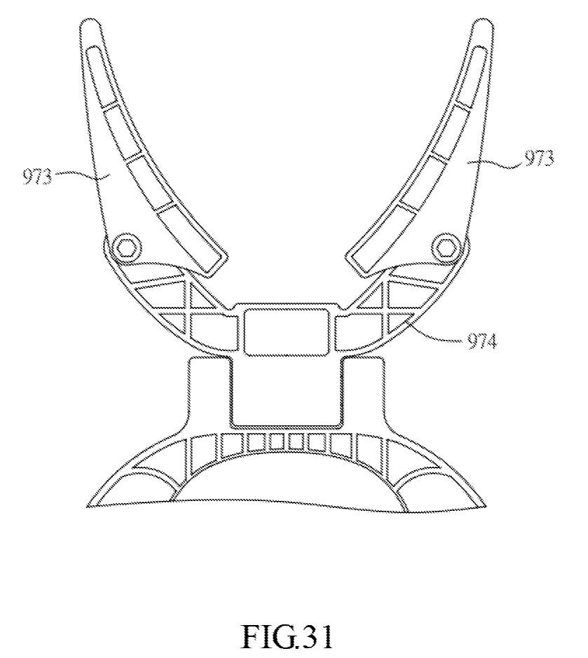

In some other embodiments, the two upper stoppers 973 can be disposed on the upper frame 93 or the handle frame 94. When the two upper stoppers 973 are disposed on the upper frame 93 or the handle frame 94, the carrier device 9 can further include an upper stopper linkage 974 as shown in FIG. 31. The upper stopper linkage 974 can have a crescent shape for example and can be disposed on the connected to the upper frame 93 or the frame arm of the handle frame 94 (which is adjacent to the handle frame linkage 95 for example). Besides, the two upper stoppers 973 can be connected with two sides of the crescent upper stopper linkage 974, so as to be indirectly connected to the upper frame 93 or the handle frame 94. In some embodiments, the upper stopper linkage 974 and the two upper stoppers 973 can be integrally formed as one piece with, for example without a limiting sense, the material of metal or plastic material.

The front wheel 911 is disposed on the end (the first end E1) of the front wheel frame 91 farther from the rear wheel frame 92, and the rear wheels 921 are disposed on two ends of the rear wheel frame 92. Physically, the front wheel 911 is installed on the front wheel frame 91 by the front wheel linkage 97 and a front wheel axle 912. In other words, the front wheel linkage 97 is disposed on a front side of the front wheel frame 91 and the front wheel 911 is installed on the front wheel linkage 97 by the front wheel axle 912, so that the front wheel 911 is installed on the front side of the front wheel frame 91 by the front wheel linkage 97.

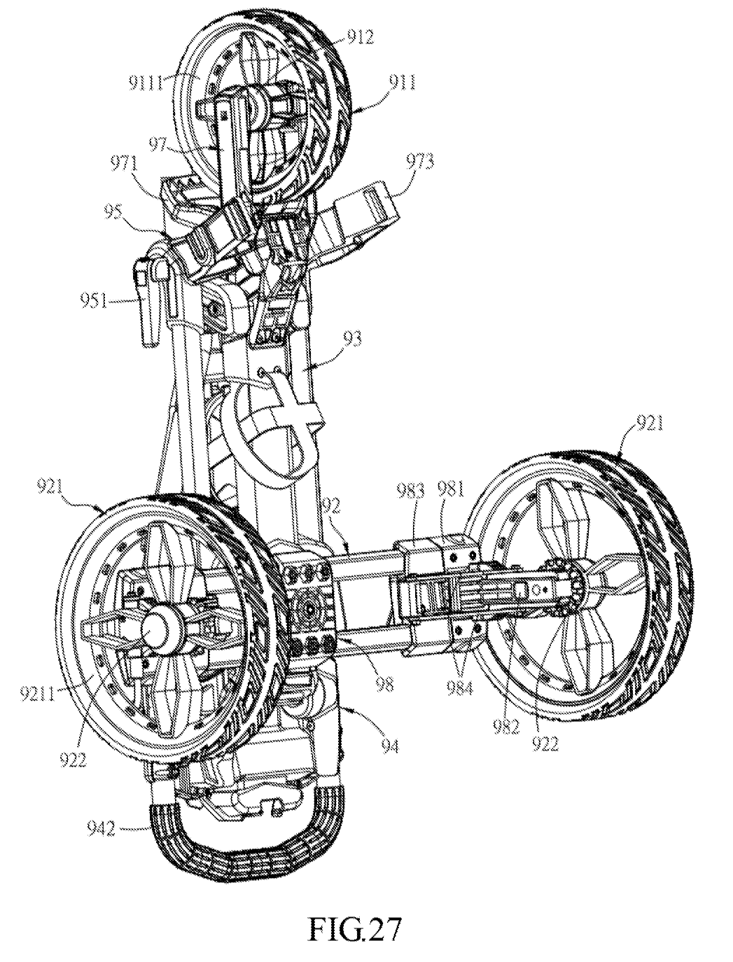

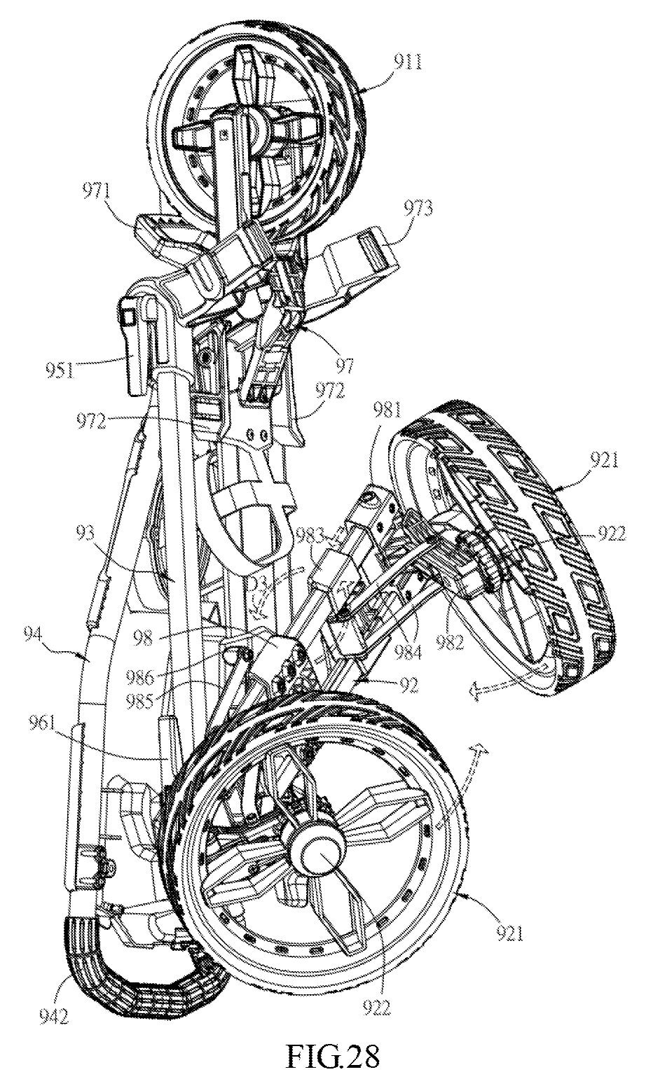

This embodiment has two rear wheels 921, which are movably disposed on two sides of the rear wheel frame 92 respectively. In different embodiments, the number of the rear wheel 921 can be different. Please refer to FIGS. 23, 27 and 28 to clearly illustrate the structure of the rear wheels 921 movably disposed on the rear wheel frame 92, and FIGS. 27 and 28 are schematic diagrams of different angles of the carrier device 9 of FIG. 23.

The rear wheels 921 are symmetrically installed to two ends of the rear wheel frame 92 by a rear wheel bracket 981, a rear wheel axle means 982 and a rear wheel axle 922. The rear wheel bracket 981 is disposed on an end of the rear wheel frame 92 and the rear wheel axle means 982 is connected to the rear wheel bracket 981 and the rear wheel axle 922, so that the rear wheels 921 can be installed to the rear wheel frame 92 through the rear wheel axle 922, the rear wheel axle means 982 and the rear wheel bracket 981. In this embodiment, for example, two rear wheel axle means 982, two rear wheel axles 922 and two rear wheels 921 are symmetrically installed to two ends of the rear wheel frame 92.

The carrier device 9 can further include a rear frame linkage 98, two rear frame sliders 983, four first linkages 984 and two second linkages 985 (FIG. 23). The rear wheel frame arms of the rear wheel frame 92 are disposed as passing through the rear frame linkage 98, and the rear frame linkage 98 is disposed on the upper frame linkage 96. Herein, the rear frame linkage 98 is rotatably connected to the upper frame linkage 96. Physically, the upper frame linkage 96 and the rear frame linkage 98 are connected to each other, and when the upper frame linkage 96 is fixed, the rear frame linkage 98 can rotate with relation to the upper frame linkage 96 by taking the upper frame linkage 96 as a center.

The rear frame slider 983 is slidably disposed on the rear wheel frame 92. In the operative position P1 of FIG. 23, two second linkages 985 (linking rods) are disposed on two sides of the upper frame linkage 96 respectively, and two second linkages 985 are connected to the upper frame linkage 96 and the rear frame slider 983 by two fixing means 986, 987, respectively. Moreover, in the operative position P1, the rear frame slider 983 contacts the rear wheel bracket 981 (FIG. 23), and each of the rear frame sliders 983 can be further connected to the corresponding rear wheel axle means 982 (FIGS. 27 and 28) by two first linkages 984 (linking rods) and fixing means (not labeled). Herein, two ends of each of the first linkages 984 are connected to the rear frame slider 983 and the rear wheel axle means 982, respectively. Therefore, when the rear frame slider 983 slides on the rear wheel frame 92 toward the direction of the rear frame linkage 98, the rear wheels 921 can be pulled by the first linkage 984 and the rear wheel axle means 982 so that the two rear wheels 921 can simultaneously move toward the direction of the rear frame linkage 98 and be collapsed.

To be noted, the rear wheel frame 92 rotating with relation to the front wheel frame 91 of the carrier device 9 of this embodiment as well as the linking mechanism is similar to the above-mentioned cart 100, and the related content can be comprehended by referring to the above description.

In order to prevent an accident sliding of the carrier device 9 during the operative state, the carrier device 9 can further include at least a rear wheel actuator 99, which is disposed on the rear wheel bracket 981 and can be used to lock the rear wheels 921 so as to stop the rotation of the rear wheels 921.

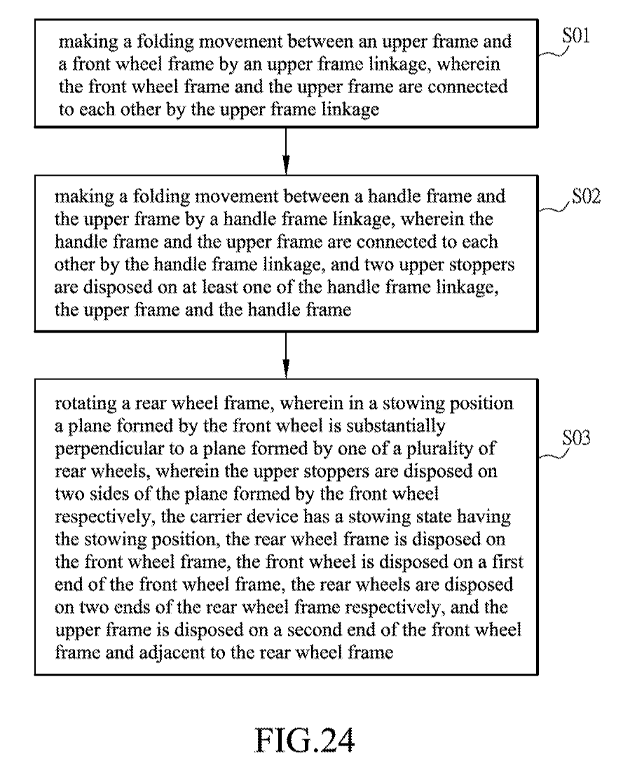

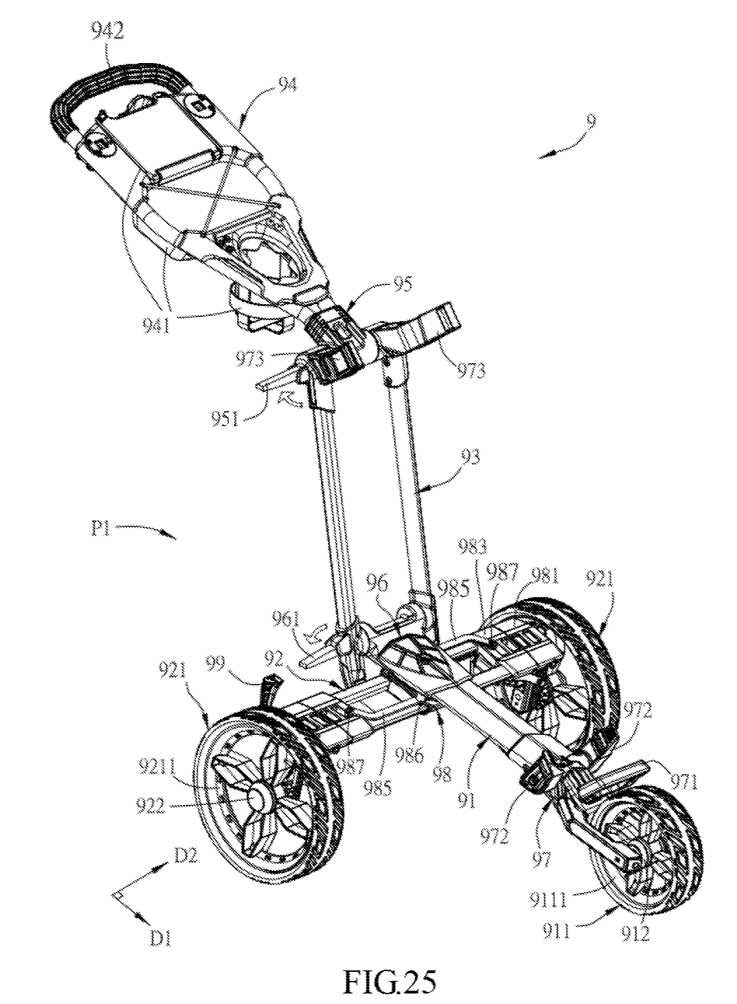

Moreover, FIG. 24 is a schematic flowchart of the stowing method of the carrier device 9 of FIG. 23, and FIGS. 25 to 30 are schematic diagrams of the stowing process of the carrier device 9 of FIG. 23. Please refer to FIG. 24 with reference to FIGS. 25 to 30 to understand the stowing process of the carrier device 9. As shown in FIG. 24, the stowing method of the carrier device 9 can include the steps S01 to S03.

The step S01 is: making a folding movement between the upper frame 93 and the front wheel frame 91 by the upper frame linkage 96, wherein the front wheel frame 91 and the upper frame 93 are connected to each other by the upper frame linkage 96. The step S02 is: making a folding movement between the handle frame 94 and the upper frame 93 by the handle frame linkage 95, wherein the handle frame 94 and the upper frame 93 are connected to each other by the handle frame linkage 95, and the two upper stoppers 973 are disposed on the handle frame linkage 95, the upper frame 93 or the handle frame 94.

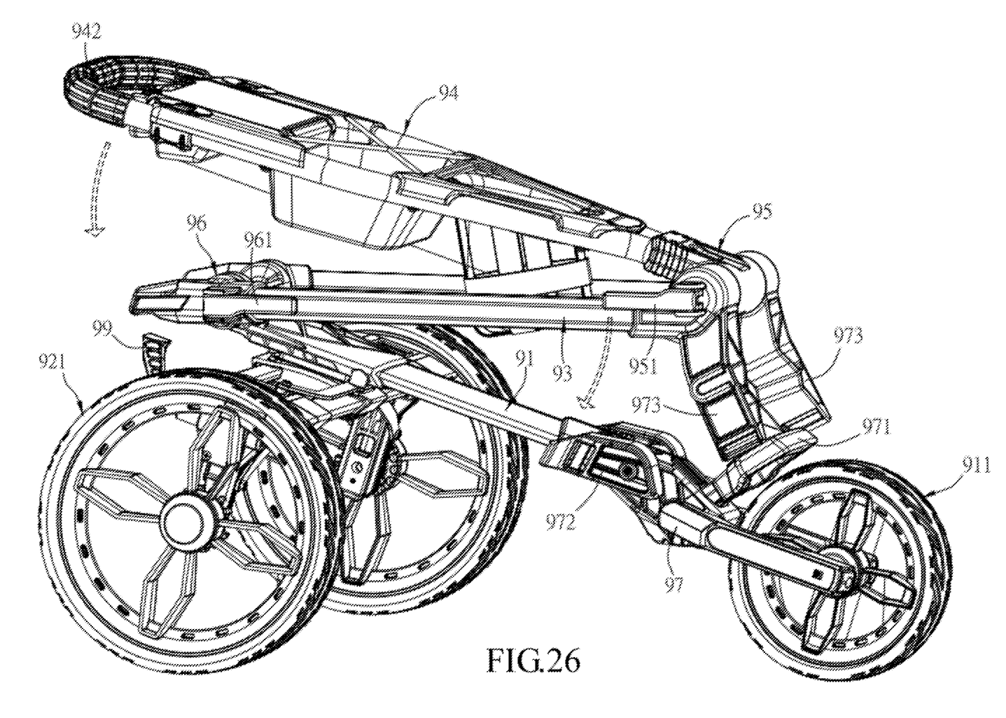

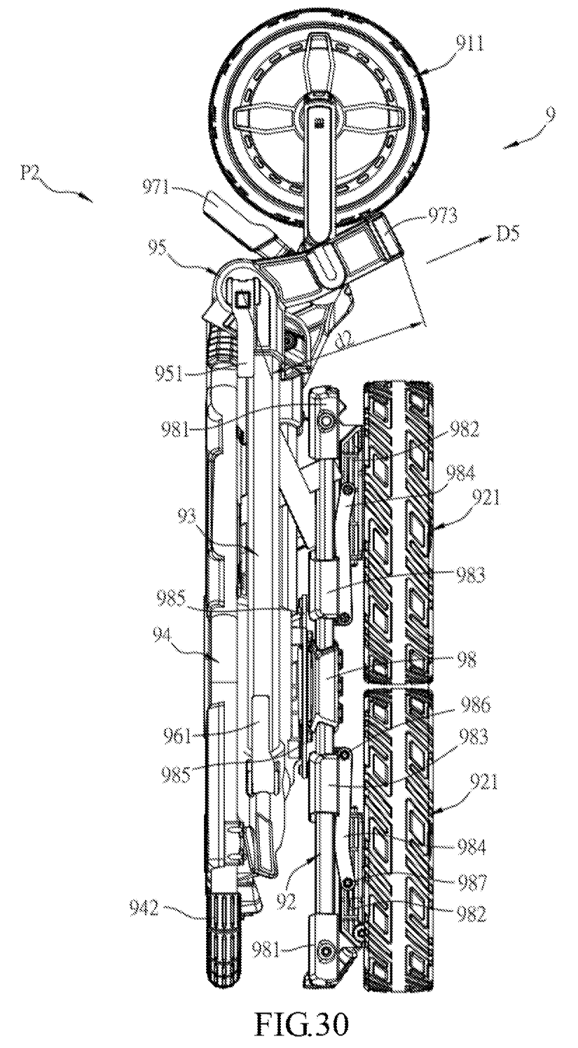

However, as shown in FIG. 23, when the carrier device 9 is in the operative position P1 of normal use, the relative position between the upper frame 93 and the front wheel frame 91 and the relative position between the handle frame 94 and the upper frame 93 are fixed and unfoldable, and the upper frame adjustment means 961 and the handle frame adjustment means 951 are fastened (the extending direction of the handle is parallel with the upper frame 93). Therefore, before the steps S01 and S02 are performed, as shown in FIG. 25, it is necessary to loose the upper frame adjustment means 961 and the handle frame adjustment means 951 to make the direction of the handle perpendicular to the upper frame 93, and then the user just can fold the handle frame 94 and the upper frame 93, as shown in FIG. 26, to make a folding movement between the handle frame 94 and the upper frame 93 (the handle frame 94 is folded toward the direction of the upper frame 93) and also to make a folding movement between the upper frame 93 and the front wheel frame 91 (the upper frame 93 is folded toward the front wheel frame 91). During the folding process, the handle frame 94, the upper frame 93 and the front wheel frame 91 can form a Z shape. However, favorably, as shown in FIG. 30, in the full stowing (the stowing position P2), the extending direction of the front wheel frame 91 (not labeled in FIG. 30), the extending direction of the rear wheel frame 92, the extending direction of the upper frame 93 and the extending direction of the handle frame 94 are substantially parallel with one another.

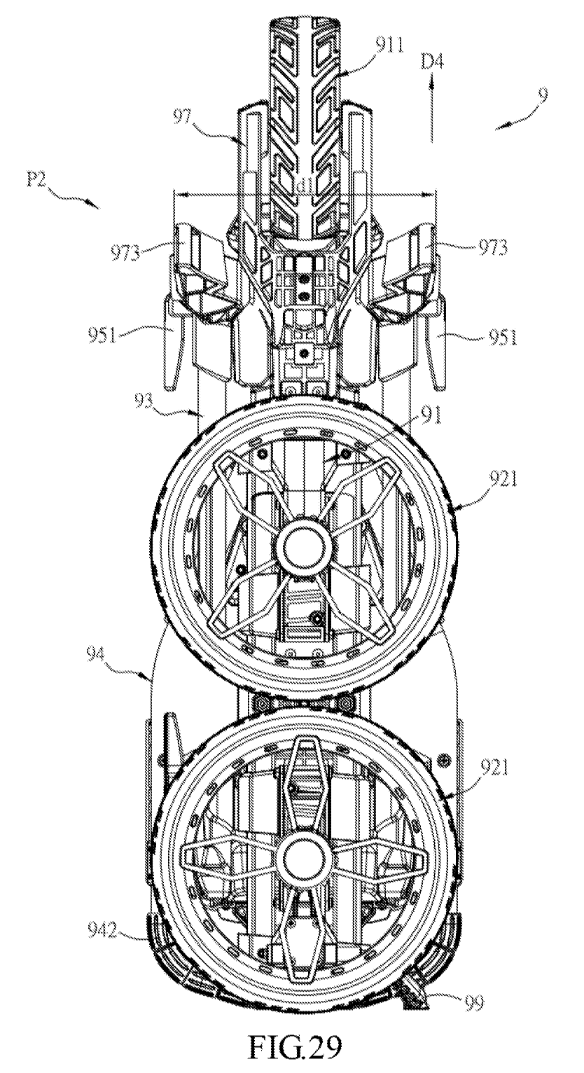

To be noted, in the operative position P1 of this embodiment (FIG. 23), the two upper stoppers 973 are disposed on two sides of the handle frame linkage 95, but this disclosure is not limited thereto. In different embodiments, the two upper stoppers 973 also can be disposed on the upper frame 93 or the handle frame 94. Moreover, during the stowing process, the two upper stoppers 973 move toward the direction of the front wheel 911 and the front wheel frame 91, and the front wheel 911, the front wheel frame 91 and the upper stopper 973 will not undergo the positional interference during the stowing process (FIGS. 26 to 28) and at the stowing state (FIGS. 29 and 30). Therefore, the relative position or state of the front wheel 911, the front wheel frame 91 or the upper stopper 973 needn't be particularly changed (the position or the direction of the front wheel 911, the front wheel frame 91 or the upper stopper 973 needn't be stowed, stretched or changed). Accordingly, the stowing process will be simpler, and besides, the upper stopper 973 can be made larger in size, or the two upper stoppers 973 can be stretched greater or their shape can be changed, as long as they will not interfere with front wheel 911 or the front wheel frame 91 during the stowing process (or the stretching process) and at the stowing state. When the upper stopper 973 has a larger size or a greater stretched width, a larger object disposed on the carrier device 9 can be avoided from falling down during the moving process.

As shown in FIG. 29, the stretched width d1 of the upper stoppers 973 of this embodiment needs to be at least 140 mm. Moreover, each of the upper stoppers 973 has a junction of a direction connection or an indirect connection with the handle frame linkage 95, the upper frame 93 or the handle frame 94 (for example, connected with the upper frame 93 or the handle frame 94 through the upper stopper linkage 974), and a distance between the junction and a distal end of the upper stopper 973 needs to be at least 60 mm. In this embodiment, as shown in FIG. 30, a distance d2 from the junction (not labeled) between each of the upper stoppers 973 and the handle frame linkage 95 to the distal end of the upper stopper 973 needs to be at least 60 mm (FIG. 30), but this disclosure is not limited thereto. In different embodiments, the stretched width d1 and the distance d2 can be different from each other.

To be noted, loosing the upper frame adjustment means 961 and loosing the handle frame adjustment means 951 can be done in different order or can be done at the same time. Besides, folding the handle frame 94 and the upper frame 93 and folding the upper frame 93 and the front wheel frame 91 also can be done in different order or can be done at the same time. In other words, the order of the steps S01 and S02 can be changed or they can be performed at the same time. After the folding movement of the frame is completed, the upper frame adjustment means 961 and the handle frame adjustment means 951 are restored to position. Moreover, as shown in FIG. 26, for smoothing the subsequent operation, before or after the steps S01 and S02 of folding the frame, the stowing method of the carrier device 9 of this disclosure can further include a step of: rotating the two lower stoppers 972 to make the extending directions of the lower stoppers 972 substantially parallel with the extending direction of the front wheel frame 91.

As shown in FIG. 27, for facilitating the subsequent stowing operation, the carrier device 9 can be rotated first to make the handle 942 of the handle frame 94 contact a surface (such as the ground). Thus, the following step S03 of rotating the rear wheel frame 92 can be performed more easily.

As shown in FIGS. 27 to 30, the step S03 is performed as rotating the rear wheel frame 92, so that, in the stowing position P2, the plane formed by the front wheel 911 is substantially perpendicular to the plane formed by one of the rear wheels, wherein the upper stoppers 973 are disposed on two sides of the plane formed by the front wheel 911 respectively, the carrier device 9 has a stowing state having a stowing position P2, the rear wheel frame 92 is disposed on the front wheel frame 91, the front wheel 911 is disposed on the first end E1 of the front wheel frame 91, the rear wheels 921 are disposed on two ends of the rear wheel frame 92 respectively, and the upper frame 93 is disposed on the second end E2 of the front wheel frame 91 and adjacent to the rear wheel frame 92.

In this embodiment, as shown in FIG. 28, the user can rotate the rear wheel frame 92 in a counterclockwise direction D3 for example (may be in a clockwise direction in a different embodiment) to make the rear wheel frame 92 rotate with relation to the upper frame linkage 96 by taking the rear frame linkage 98 as a center, so that the two rear frame sliders 983 can slide on the rear wheel frame 92 and thus approach the direction of the rear frame linkage 98 by the correspondingly connected second linkages 985 (shown in FIG. 25 instead of FIG. 28). While the rear frame sliders 983 approach the rear frame linkage 98, the rear frame sliders 983 will pull the rear wheel axle means 984 to move toward the direction of the rear wheel frame 92 through the first linkage 984 and fixer thereof (not labeled), so that the two rear wheels 921 also move toward the direction of the rear wheel frame 92 at the same time. Thereby, when it is in the stowing position P2, the plane formed by the rear wheels 921, the extending direction of the front wheel frame 91 (not shown in FIG. 30), the extending direction of the rear wheel frame 92, the extending direction of the upper frame 93 and the extending direction of the handle frame 94 are substantially parallel with one another. Furthermore, in the stowing position P2, the plane formed by the front wheel 911 and the plane formed by one of the rear wheels 921 are substantially perpendicular to each other. Herein, the rear wheels are arranged into a line, and the plane formed by the front wheel 911 is perpendicular to the plane formed by each of the rear wheels 921.

Moreover, in the stowing position P2 of FIG. 29, the upper stoppers 973 don't contact the rear wheel 911, the upper stoppers 973 will be disposed on two sides of the plane formed by the rear wheel 911, and the upper stoppers 973 are disposed on two sides of the extending direction D4 of the front wheel frame 91 (without positional interference). Moreover, in the stowing position P2 of FIG. 30, the outward extending direction D5 of the upper stopper 973 is not parallel with the plane formed by the rear wheel 921.

Thus, in this embodiment, the rear wheel 911, the front wheel frame 91 and the upper stoppers 973 of the carrier device 9 will not undergo the positional interference during the stowing process (or the stretching process) and at the stowing state. Therefore, the position or the state of the front wheel 911, the front wheel frame 91 or the upper stopper 973 needn't be particularly changed. Besides, from the above-mentioned stowing process, it can be seen that the carrier device 9 of this embodiment can be turned into the stowing state from the operative state through simple and fast folding steps and can be turned into the operative state from the stowing state through the simple and fast reverse operation. Therefore, from the above-mentioned folding and stowing process, it can be seen the carrier device 9 of this embodiment not only has the advantage of easy folding, but also won't take too much room after the folding, so as to facilitate the carrying, transportation or storage for the user.

Therefore, in the above-mentioned carrier device (the carrier device 9) and the stowing method thereof, the front wheel is disposed on the first end of the front wheel frame, the rear wheel frame is disposed on the front wheel frame, the rear wheels are disposed on two ends of the rear wheel frame respectively, and the upper frame is disposed on the second end of the front wheel frame and adjacent to the rear wheel frame. Moreover, the handle frame is disposed on the upper frame, the handle frame and the upper frame are connected to each other by the handle frame linkage, and the upper stoppers are disposed on the handle frame linkage, the upper frame or the handle frame. The stowing state of the carrier device has a stowing position, and when it is in the stowing position, the plane formed by the front wheel and the plane formed by one of rear wheels are substantially perpendicular to each other, and the upper stoppers are disposed on two sides of the plane formed by the front wheel respectively. By the above design, the carrier device will have a very simple stowing or stretching process, and besides, the front wheel, the front wheel frame and the two upper stoppers will not undergo the positional interference during the stowing process and at the stowing state. Therefore, the carrier device of this disclosure not only has the advantage of easy folding, but also won't take too much room after the folding, so as to facilitate the carrying, transportation or storage for the user.

Although the disclosure has been described with reference to specific embodiments, this description is not meant to be construed in a limiting sense. Various modifications of the disclosed embodiments, as well as alternative embodiments, will be apparent to persons skilled in the art. It is, therefore, contemplated that the appended claims will cover all modifications that fall within the true scope of the disclosure.

What is claimed is:

1. A carrier device, comprising:
a front wheel frame including a first end and a second end;
a rear wheel frame disposed on the front wheel frame;
a front wheel disposed on the first end of the front wheel frame;
a plurality of rear wheels disposed on two ends of the rear wheel frame;
an upper frame disposed on the second end of the front wheel frame and adjacent to the rear wheel frame;
a handle frame disposed on the upper frame;
a handle frame linkage, through which the handle frame and the upper frame are connected to each other; and
two upper stoppers disposed on at least one of the handle frame linkage, the upper frame and the handle frame;
wherein the carrier device has a stowing state including a stowing position, in the stowing position, a plane formed by the front wheel and a plane formed by one of the rear wheels are substantially perpendicular to each other, and the upper stoppers are disposed on two sides of the plane formed by the front wheel respectively.

2. The carrier device as recited in claim 1, wherein the handle frame is folded with relation to the upper frame by the handle frame linkage.

3. The carrier device as recited in claim 1, further comprising:
a handle frame adjustment means disposed on the handle frame linkage to control a folding movement between the handle frame and the upper frame.

4. The carrier device as recited in claim 1, further comprising:
an upper frame linkage, wherein the front wheel frame and the upper frame are connected to each other by the upper frame linkage, and the upper frame is folded with relation to the front wheel frame by the upper frame linkage.

5. The carrier device as recited in claim 4, wherein the carrier device further has an operative state including an operative position, and in the operative position, the upper frame or the upper frame linkage is disposed against the rear wheel frame.

6. The carrier device as recited in claim 4, further comprising:
an upper frame adjustment means disposed on the upper frame linkage to control a folding movement between the upper frame and the front wheel frame.

7. The carrier device as recited in claim 4, further comprising:
a rear frame linkage disposed on the upper frame linkage, wherein the rear wheel frame passes through the rear frame linkage.

8. The carrier device as recited in claim 7, further comprising:
a rear wheel bracket disposed on one of the two ends of the rear wheel frame; and
a rear wheel axle means connected with the rear wheel and the rear wheel bracket.

9. The carrier device as recited in claim 8, further comprising:
a rear frame slider disposed on the rear wheel frame, connected to the rear wheel axle means by a first linkage, and further connected to the upper frame linkage by a second linkage.

10. The carrier device as recited in claim 1, wherein a stretched width of the upper stoppers is at least 140 mm, each of the upper stoppers has a junction with at least one of the handle frame linkage, the upper frame and the handle frame, and a distance between the junction and a distal end of the upper stopper is at least 60 mm.

11. The carrier device as recited in claim 1, wherein in the stowing position, an outward extending direction of each of the upper stoppers is not parallel with the plane formed by the rear wheel.

12. The carrier device as recited in claim 1, wherein in the stowing position, the upper stoppers don't contact the front wheel, and the upper stoppers are disposed on two sides of an extending direction of the front wheel frame respectively.

13. A stowing method of a carrier device, comprising steps of:
making a folding movement between an upper frame and a front wheel frame by an upper frame linkage, wherein the front wheel frame and the upper frame are connected to each other by the upper frame linkage;
making a folding movement between a handle frame and the upper frame by a handle frame linkage, wherein the handle frame and the upper frame are connected to each other by the handle frame linkage, and two upper stoppers are disposed on at least one of the handle frame linkage, the upper frame and the handle frame; and
rotating a rear wheel frame, wherein in a stowing position a plane formed by the front wheel is substantially perpendicular to a plane formed by one of a plurality of rear wheels, wherein the upper stoppers are disposed on two sides of the plane formed by the front wheel respectively, the carrier device has a stowing state having the stowing position, the rear wheel frame is disposed on the front wheel frame, the front wheel is disposed on a first end of the front wheel frame, the rear wheels are disposed on two ends of the rear wheel frame respectively, and the upper frame is disposed on a second end of the front wheel frame and adjacent to the rear wheel frame.

14. The stowing method as recited in claim 13, before the step of making a folding movement between the upper frame and the front wheel frame, further comprising a step of:
loosing an upper frame adjustment means, wherein the upper frame adjustment means is disposed on the upper frame linkage to control the folding movement between the upper frame and the front wheel frame.

15. The stowing method as recited in claim 14, further comprising a step of:
restoring the upper frame adjustment means to position.

16. The stowing method as recited in claim 13, before the step of making a folding movement between the handle frame and the upper frame, further comprising a step of:
loosing a handle frame adjustment means, wherein the handle frame adjustment means is disposed on the handle frame linkage to control the folding movement between the handle frame and the upper frame.

17. The stowing method as recited in claim 13, further comprising a step of:
rotating two lower stoppers to make extending directions of the lower stoppers substantially parallel with an extending direction of the front wheel frame, wherein a front wheel linkage is disposed between the front wheel and the front wheel frame and the lower stoppers are disposed on two sides of the front wheel linkage.

18. The stowing method as recited in claim 13, wherein a stretched width of the upper stoppers is at least 140 mm, each of the upper stoppers has a junction with at least one of the handle frame linkage, the upper frame and the handle frame, and a distance between the junction and a distal end of the upper stopper is at least 60 mm

19. The stowing method as recited in claim 13, wherein in the stowing position an outward extending direction of each of the upper stoppers is not parallel with the plane formed by the rear wheel,

20. The stowing method as recited in claim 13, wherein in the stowing position the upper stoppers don't contact the front wheel, and the upper stoppers are disposed on two sides of an extending direction of the front wheel frame respectively.
